(19) United States
(12) Patent Application Publication
(10) Pub. No.: US 2024/0378377 A1
(43) Pub. Date: Nov. 14, 2024

(54) Controversy Resolution Assistant Engine Machine Learning Apparatuses, Processes and Systems

(71) Applicant: Battle Tested, Reno, NV (US)

(72) Inventor: Edward Katzin, Reno, NV (US)

(21) Appl. No.: 18/662,937

(22) Filed: May 13, 2024

Related U.S. Application Data
(60) Provisional application No. 63/466,267, filed on May 13, 2023.
(60) Provisional application No. 63/472,318, filed on Jun. 11, 2023.

(51) Int. Cl. G06F 40/186; G06F 40/30

(52) U.S. Cl. CPC G06F 40/186; G06F 40/30

(57) ABSTRACT

The Controversy Resolution Assistant Engine Machine Learning Apparatuses, Processes and Systems (“CRAEML”) transforms matter milestone interaction input datastructure/inputs via CRAEML components into matter milestone interaction output outputs. A matter milestone interaction request datastructure is obtained. Milestone document details are determined via an NLP engine. The milestone document details are evaluated via a first ML prediction logic datastructure to determine relevant matter data. Similar prior matters are determined by executing a search query. The milestone document details, the relevant matter data and similar prior matters data are evaluated via a second ML prediction logic datastructure to determine a best matching resolution document template. Template placeholder values for a template placeholder of the best matching resolution document template are generated via an LLM. User selection of a template placeholder value is obtained. Content of the best matching resolution document template and the selected template placeholder value are composited generating a resolution document.

This application for letters patent disclosure document describes inventive aspects that include various novel innovations (hereinafter “disclosure”) and contains material that is subject to any of: copyright, mask work, and/or other intellectual property protection. The respective owners of such intellectual property have no objection to the facsimile reproduction of the disclosure by anyone as it appears in published Patent Office file/records, but otherwise reserve all rights.

### PRIORITY CLAIM

Applicant hereby claims benefit to priority under 35 USC § 119 as a non-provisional conversion of: U.S. provisional patent application Ser. No. 63/466,267, filed May 13, 2023, entitled “Controversy Resolution Assistant Engine Machine Learning Apparatuses, Processes and Systems”, (attorney docket no. BattleTested0001PV).

Applicant hereby claims benefit to priority under 35 USC § 119 as a non-provisional conversion of: U.S. provisional patent application Ser. No. 63/472,318, filed Jun. 11, 2023, entitled “Controversy Resolution Assistant Engine Machine Learning Apparatuses, Processes and Systems”, (attorney docket no. BattleTested0001PV2).

The entire contents of the aforementioned applications are herein expressly incorporated by reference.

### FIELD

The present innovations generally address machine learning, and more particularly, include Controversy Resolution Assistant Engine Machine Learning Apparatuses, Processes and Systems.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. § 112.

### BACKGROUND

Macros have allowed for some automation of computer tasks.

### BRIEF DESCRIPTION OF THE DRAWINGS

Appendices and/or drawings illustrating various, non-limiting, example, innovative aspects of the Controversy Resolution Assistant Engine Machine Learning Apparatuses, Processes and Systems (hereinafter “CRAEML”) disclosure, include:

FIG. 1 shows non-limiting, example embodiments of an architecture for the CRAEML;

FIG. 2 shows non-limiting, example embodiments of a datagraph illustrating data flow(s) for the CRAEML;

FIG. 3 shows non-limiting, example embodiments of a logic flow illustrating a matter milestone interaction processing (MMIP) component for the CRAEML;

FIGS. 4A-B show non-limiting, example embodiments of implementation case(s) for the CRAEML;

FIGS. 5A-C show non-limiting, example embodiments of implementation case(s) for the CRAEML;

FIG. 6 shows non-limiting, example embodiments of implementation case(s) for the CRAEML;

FIG. 7 shows a block diagram illustrating non-limiting, example embodiments of a CRAEML controller;

APPENDICES 1-4 illustrate embodiments of the CRAEML.

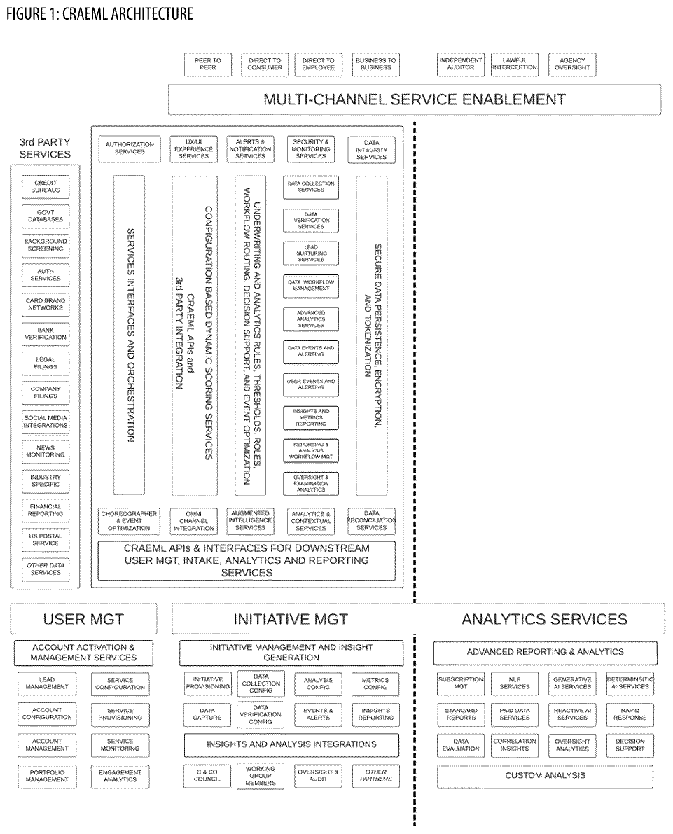

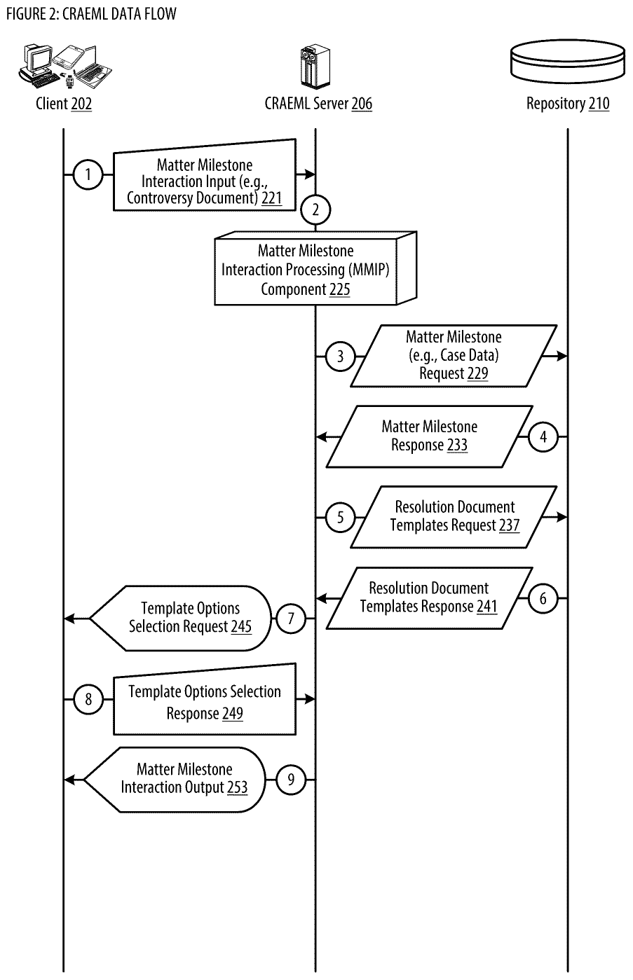

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citations and/or reference numbers are not necessarily sequences but rather just example orders that may be rearranged and other orders are contemplated. Citation number suffixes may indicate that an earlier introduced item has been re-referenced in the context of a later figure and may indicate the same item, evolved/modified version of the earlier introduced item, etc., e.g., server 199 of FIG. 1 may be a similar server 299 of FIG. 2 in the same and/or new context.

### DETAILED DESCRIPTION

The Controversy Resolution Assistant Engine Machine Learning Apparatuses, Processes and Systems (hereinafter “CRAEML”) transforms matter milestone interaction input datastructure/inputs, via CRAEML components (e.g., MMIP, etc. components), into matter milestone interaction output outputs. The CRAEML components, in various embodiments, implement advantageous features as set forth below.

### Introduction

The CRAEML provides unconventional features (e.g., using an ML component to determine resolution document templates that best match a milestone document for a matter, using an AI component to generate template placeholder values constructed to have the highest likelihood of producing a successful outcome with regard to the milestone document and/or in a specified venue, generating a resolution document composited in accordance with a user's selections of a resolution document template to utilize, template placeholder values to utilize, and a venue to utilize, and incorporating feedback for the generated resolution document to improve performance of the AI component and/or of the ML component) that were never before available in machine learning.

In one embodiment, the CRAEML may be utilized to streamline and automate various processes involved in legal cases or any dispute resolution negotiation or mediation process. By leveraging technology and artificial intelligence, the system may enhance efficiency, accuracy, and data management in any court system, alternative dispute resolution forum, or mediation process. The CRAEML may comprise automated client intake, information collection, contextual analysis, issues evaluation, case vetting, pattern recognition, document filing, data management, and communication handling, among other features. The CRAEML may be utilized to provide a comprehensive and automated solution for legal professionals, negotiators, and individuals involved in legal proceedings, dispute resolution, or negotiations.

In one embodiment, the CRAEML may utilize automation, artificial intelligence, and machine learning to optimize various aspects of legal proceedings, dispute resolution process or negotiations. The system enables automated client intake, information collection, vetting, contextual analysis, pattern recognition, document generation, document filing, data management, and communication handling. The system tracks the key points and issues associated with the legal proceeding or negotiation. By incorporating advanced algorithms and interfaces, the CRAEML may be utilized to streamline the legal process, negotiations, analyze options for dispute resolution, assess likelihood of specific outcomes, refine the arguments or positions to improve likelihood of desired outcomes, improve efficiency, and provide real-time support to legal professionals, negotiators, and their clients. The system also ensures the integrity of information, evidence, metadata tagging, and references through auditable data linage of information used by the system within documents generated, documents filed, and documents shared by the parties engaged in the legal proceeding, dispute resolution, or negotiation. The CRAEML may revolutionize the legal proceedings, dispute resolution, and negotiations by leveraging technology to expedite and enhance information collection, analysis of positions and/or arguments, case management, and optimization of information used, arguments applied, and negotiating position to improve the likelihood of desired outcomes.

### Exemplary Details

Automated client intake including ingestion of information about the individual and their legal matter, dispute, or negotiation position: The system automates the process of gathering relevant information about clients and the matter at hand, the pertinent issues, arguments, and positions, eliminating the need for manual data entry and reducing human error.

Automated vetting of client and their legal matter, dispute, or negotiating position: Through predetermined criteria and algorithms, the system automatically evaluates and assesses the client's eligibility and the legal matter's (or dispute or negotiating position's) viability, ensuring efficient use of resources.

Automated pattern recognition of the legal matter information vs. history of prior cases in the specific state of filing and across the courts: The system employs pattern recognition algorithms to compare the details of the legal matter with historical data from the specific state and nationwide court cases. This helps identify patterns, precedents, and potential outcomes.

Deterministic AI techniques to identify the likely patterns and probability of specific events in the legal matter: The system employs deterministic artificial intelligence techniques to analyze the gathered data and predict the likelihood of specific events occurring during the legal proceedings, dispute resolution process or negotiation, providing valuable insights to legal professionals, negotiators, and their clients.

Automated interfaces for electronic filing of documents, petitions, motions, and responses in each state: The system provides automated interfaces that enable electronic filing of documents, petitions, motions, and responses utilized in legal proceedings, dispute resolution, and negotiations. This feature streamlines the filing process and ensures compliance with jurisdiction-specific regulations.

Automated interfaces for the ingestion of notices from the court, opposing counsel, opposing parties, experts, and client: The system facilitates the automated ingestion of notices received from the court, opposing counsel, opposing parties, experts, and clients. This ensures timely and accurate communication, reducing the chances of missed deadlines or important information.

Automated data management including analysis of structured, unstructured, and semi-structured data with classification, enrichment, tagging and labeling for efficient data management and searching using AI/ML: The system incorporates advanced data management techniques, including analysis of structured, unstructured, and semi-structured data. It utilizes artificial intelligence and machine learning algorithms to classify, tag, label, and organize data, enabling efficient management and retrieval.

Automated generation of responses to issues, negotiating positions, motions, petitions, and opposing counsel (or opposing party) communication: Using natural language processing and predefined response templates, the system generates automated responses to motions, petitions, and communications from opposing counsel (or opposing party). This saves time for legal professionals, negotiators, and/or the like and ensures consistent and accurate responses.

Automated review of final judgments and stipulations to identify integrity with applicable laws and regulations in, for example, family court, criminal and civil court systems of the United States: The system automatically reviews final judgments and stipulations, comparing them against applicable laws and regulations in, for example, family court and other relevant legal domains such as criminal and civil court systems.

Pull the filings in open source via digital download (e.g., charge per page)—get the case files: The system has the capability to retrieve case filings from open-source platforms through digital downloads. It may charge a fee per page for accessing and obtaining the complete set of case files. The system may access available court documents, filings, laws, and regulations.

Ingest the filings via email: The system allows the ingestion of case filings received via email. This feature ensures that relevant documents are seamlessly incorporated into the system for further processing and analysis. Filings can also be ingested via web forms, APIs, and file formats.

Filings are in PDF: The system may utilize filings be in PDF format, which is a widely used standard for electronic documents. PDF files provide consistency and compatibility across different devices and platforms.

Reader to convert it from PDF to Text Data: The system includes a PDF-to-text conversion functionality, which allows the extraction of text data from the PDF files. This conversion enables further analysis and processing of the textual content. The system has the ability to OCR PDFs and images.

### Ingest the Data

Structured: The system ingests structured data, which includes organized and labeled information, such as case details, negotiation details, contextual information, parties involved, dates, and other structured elements present in the filings.

Semi-structured: The system can handle semi-structured data, which contains a combination of structured and unstructured elements. This may include partially labeled or categorized information.

Unstructured: The system is designed to handle unstructured data, which comprises text and content without a predefined organization or format. This allows the system to analyze and extract meaningful insights from the unstructured information present in the filings. This includes video, audio, image, and other unstructured data formats.

Run NLP on the filings: The system utilizes Natural Language Processing (NLP) techniques to analyze the textual content of the filings. NLP enables the system to extract relevant information, identify key concepts, and understand the context within the documents.

Do the tagging and labeling of the data: The system applies tagging and labeling techniques to the data extracted from the filings. This process involves assigning specific categories, metadata, or labels to the information, making it easier to organize, search, and retrieve data during subsequent stages.

Pull the metadata from the eFiling Service (e.g., including source IP address): The system retrieves metadata associated with the filings from the eFiling service. This includes information such as the source IP address, timestamps, and other relevant metadata attributes. Analyzing metadata can provide additional insights and aid in tracking the origin and history of the filings.

Create the language of the opposing attorney (or opposing party): The system generates a language model that simulates the writing style and language patterns typically used by opposing attorneys. This allows for accurate and contextually appropriate responses to be generated based on the language of the opposing party.

Generate responses based on their language: Utilizing the created language model, the system generates responses that align with the language and arguments presented by the opposing attorney. This feature helps legal professionals, negotiators, and/or the like provide timely and relevant responses in a consistent manner.

Identify the ‘hearsay’ part and avoid getting caught in it: The system employs algorithms and linguistic analysis to identify and flag any potentially unreliable or hearsay information within the filings or any documents submitted. By recognizing and avoiding such content, the system helps ensure the accuracy and integrity of the legal arguments and negotiating positions.

Handling of Exhibits that should be attached as proof of what is said: The system determines the appropriate handling of exhibits that serve as evidence to support the claims made within the filings. It ensures that the exhibits are appropriately attached and referenced, reinforcing the credibility of the arguments presented.

Bates Stamp Exhibits; when evidence is filed, it should be in a Bates stamp format: The system employs a “Bates stamp” format for exhibits submitted as evidence. This format ensures that when evidence is filed, it includes a Bates stamp format. Bates stamping involves the application of unique identifiers, such as stamps or marks, to the exhibits. This helps to establish the authenticity, integrity, and traceability of the evidence throughout the legal process.

When evidence is uploaded from clients, they should provide an identifying keyword to upload (e.g., DCFS, Protective Orders, Abuse Report, etc.): The system prompts clients to include an identifying keyword when uploading evidence. This keyword helps categorize and organize the evidence based on relevant topics or issues, such as DCFS (Department of Children and Family Services), Protective Orders, Abuse Report, and others.

When the system initiates the filing, it matches the Bates stamps and puts together the exhibits: During the filing process, the system matches the Bates stamps on the exhibits with the corresponding documents. By doing so, it ensures that the exhibits are correctly associated with the relevant filings, maintaining the integrity and accuracy of the evidence presented.

The system has the ability to view videos, photos/images, and listen to audio evidence and ensure the integrity of the metadata tagging and references in the filings (e.g., confirm the accuracy of the dates, event data, etc.): The system provides the capability to view videos, photos/images, and listen to audio evidence. This functionality allows legal professionals, negotiators, and/or the like to assess the content of the evidence accurately. Additionally, the system verifies the integrity of metadata tagging and references within the filings, ensuring the accuracy of dates, event data, and other contextual information.

When emails come in, they are routed to a firm (or company), and the response is generated and sent back. The response to the client is based on the nature of the email, providing messages of encouragement, strength, and hope. Rapid responses are provided to emails in real-time, reassuring clients that they have a dedicated service provider promptly addressing their concerns and providing ongoing support.

### Types of Legal Matters & Negotiations

Civil cases in the United States encompass a broad range of legal disputes between individuals or entities. These cases involve claims that one party has failed to fulfill a legal responsibility owed to another party. In Family Court, civil cases specifically pertain to legal issues concerning family relationships and matters related to domestic disputes. Let's explore the types of civil cases, with a focus on Family Court cases.

Divorce and Dissolution of Marriage: Family Court handles cases related to divorce and dissolution of marriage. These cases involve the legal termination of a marital union, including issues such as property division, spousal support, child custody, visitation rights, and child support. The court seeks to ensure a fair resolution that safeguards the best interests of any children involved.

Child Custody and Visitation: Family Court also handles cases related to child custody and visitation rights. These cases arise when parents or guardians are unable to agree on the custody arrangements for their children following a divorce or separation. The court considers factors such as the child's best interests, parental fitness, and the ability to provide a stable environment when making custody determinations.

Child Support: Cases involving child support are another common type of civil case in Family Court. These cases address the financial responsibility of parents to provide financial support for their children. The court considers factors such as the income of both parents, the child's needs, and the custody arrangement when determining the appropriate amount of child support.

Domestic Violence and Restraining Orders: Family Court handles cases involving domestic violence, abuse, or harassment within family relationships. These cases may result in the issuance of protective orders or restraining orders to ensure the safety and well-being of individuals affected by domestic violence. The court aims to provide necessary protection and remedies for victims of domestic abuse.

Adoption and Guardianship: Family Court also oversees cases related to adoption and guardianship. These cases involve the legal process of establishing a legal parent-child relationship between individuals who are not biologically related. The court ensures that adoptions and guardianships are carried out in accordance with applicable laws and regulations, prioritizing the best interests of the child.

It is to be understood that the specific types of civil cases in Family Court can vary based on jurisdiction, as different states may have their own laws and procedures. Additionally, Family Court may handle other civil matters related to family law, including probate cases, domestic partnership disputes, and child protection cases.

In civil cases, the process typically begins when the plaintiff files a complaint describing their claim and serves a copy of the complaint on the defendant. Both parties, referred to as litigants, present their arguments and evidence to the court. The court may encourage the parties to engage in alternative dispute resolution methods, such as mediation or arbitration, to reach a resolution without the need for a trial. If a resolution is not reached, the court will proceed with a trial, during which the judge or jury will make a determination based on the evidence and applicable laws.

Civil Cases in the United States: These cases encompass a wide spectrum of legal disputes between individuals or entities. Such disputes often arise from allegations that one party has failed to fulfill a legal duty owed to another. These matters are not limited to, but include, areas such as contract disputes, real estate transactions, and personal injury claims.

Family Court: Specializes in disputes and legal issues that arise within family relationships, including divorce and dissolution of marriage, child custody, visitation rights, child and spousal support, domestic violence, and the issuance of restraining orders. It also handles adoption and guardianship matters, ensuring that proceedings prioritize the welfare of the child.

Commercial Law: Covers a broad range of business-related issues including business formation and governance, mergers and acquisitions, intellectual property rights, and business dissolution or disputes.

Contracts and Agreements: Involves drafting, reviewing, and negotiating various types of contracts such as employment contracts, business ventures, leases, and more. This area ensures that agreements are legally binding and enforceable, and that they protect the interests of the parties involved.

Criminal Law: Represents individuals accused of crimes, managing aspects from arraignment through to trial or settlement, including plea bargaining and sentencing.

Estate Planning and Probate: Includes drafting wills and trusts, powers of attorney, and handling probate processes. This area ensures that an individual's estate is managed and disposed of in accordance with their wishes and the law.

Real Estate Law: Deals with buying, selling, and leasing property, as well as managing zoning laws and development issues. This field also includes negotiations related to real estate transactions.

Tax Law: Handles legal matters related to filing tax returns, managing audits, and resolving disputes with tax authorities.

International Law: Encompasses international trade, cross-border transactions, foreign investment, and handling of international disputes through arbitration or litigation.

Employment Law: Focuses on workplace issues such as discrimination, wrongful termination, and disputes over employment terms and conditions.

Consumer Law: Deals with issues such as debt collection, product liability, and false advertising, ensuring that consumers' rights are protected under the law.

Commercial Negotiations: CRAEML services extend beyond legal matters and court cases and may be utilized in a wide variety of areas and/or industries, and may, for example, include support for dispute resolution and business negotiations. This encompasses a wide range of commercial dealings such as mergers and acquisitions, joint ventures, licensing agreements, and other strategic business transactions, facilitating effective negotiation and resolution strategies.

Process and Negotiations: Typically begins with the filing of a complaint by the plaintiff, detailing their grievance. The complaint is served on the defendant, and both parties engage in presenting evidence and arguments. The court often encourages alternative dispute resolution methods like mediation or arbitration to settle disputes without a trial. If unresolved, the matter proceeds to trial for a judicial decision.

### Pro Se Representation in Legal Matters

Pro se representation refers to a situation in which an individual decides not to be represented by an attorney in a civil or criminal court case. The term “pro se” is derived from Latin and translates to “on one's own behalf.” The individual is “in propria persona,” which means “in one's own person.” It signifies that an individual is acting as their own legal representative without the assistance of legal counsel.

In the context of Family Court, pro se representation refers to an individual representing themselves in legal matters related to any legal matter including family law. Family law encompasses various issues concerning family relationships, including marriage, divorce, child custody, child support, and related economic matters. Pro se litigants have the right to choose self-representation during family court proceedings, including divorce cases, without being obligated to hire an attorney.

It is worth noting that while the law allows individuals to act as pro se litigants, there are certain limitations and considerations to keep in mind. For instance, pro se litigants cannot represent others; they can only represent themselves. Furthermore, family court procedures may vary depending on the jurisdiction, so it is important to familiarize oneself with the specific rules and requirements of the court where the case is being heard.

Pro se litigants in family court are responsible for performing legal tasks typically undertaken by an attorney, including preparing and filing legal documents, presenting evidence, making legal arguments, and navigating court procedures. While self-representation can offer cost savings, it is crucial to recognize that family law matters can be complex, emotionally charged, and legally intricate. As a result, individuals considering pro se representation in family court should carefully assess their knowledge, skills, and ability to effectively advocate for their interests.

Family courts often offer resources to assist pro se litigants, such as family law facilitators, who provide information and guidance on the necessary forms, procedures, and available resources. These facilitators can help individuals navigate the family court system and understand their legal rights and responsibilities.

In summary, pro se representation in the context of family court refers to individuals representing themselves without the assistance of an attorney in legal matters related to family law. Individuals considering pro se representation should be aware of the specific rules and requirements of their jurisdiction and to carefully assess their ability to effectively handle their case. Family court resources, such as family law facilitators, can provide valuable assistance and guidance throughout the process.

### Parties & Actors Involved

In a legal matter or Court Case, multiple parties and actors may be involved, each playing a specific role in the legal proceedings. These individuals and entities contribute to the resolution of legal issues. Below is a list of the parties and actors typically involved in Court Cases, along with a description of each:

Plaintiff/Petitioner: The plaintiff or petitioner is the party who initiates the Family Court case by filing a complaint or petition. This individual brings forth the legal claims or requests relief from the court regarding the family-related matter at hand. The plaintiff/petitioner may be an individual, such as a spouse seeking a divorce, a parent seeking custody, or a relative filing for guardianship.

Defendant/Respondent: The defendant or respondent is the party against whom the Family Court case is filed. This individual is the subject of the legal claims made by the plaintiff/petitioner and must respond to the allegations and requests made in the complaint or petition. The defendant/respondent may be an individual, such as a spouse being sued for divorce or a parent responding to a custody petition.

Child/Children: In cases involving child custody, visitation, or child support, the child or children are the subjects of the legal proceedings. Their best interests and well-being are central to the decisions made by the court. While not direct parties to the case, their welfare is a key consideration.

Attorneys/Lawyers: Attorneys or lawyers represent the parties involved in the Family Court case. The plaintiff/petitioner and defendant/respondent may each have their own legal counsel who provides legal advice, prepares legal documents, presents arguments, and represents their respective interests in court. Attorneys play a crucial role in advocating for their clients' rights and guiding them through the legal process.

Judges/Magistrates: Judges or magistrates preside over Family Court cases and have the authority to make legal decisions and rulings based on the evidence, arguments, and applicable laws. They ensure that proceedings are conducted fairly, interpret and apply the law, and issue final judgments or orders. Judges play a pivotal role in resolving disputes and determining the outcomes of Family Court cases.

Court Personnel: Various court personnel support the functioning of the Family Court system. This may include clerks, court administrators, and other administrative staff responsible for managing the case files, scheduling hearings, processing paperwork, and assisting litigants with procedural matters. They facilitate the smooth operation of the court proceedings.

Experts: Experts may be involved in Family Court cases when specialized knowledge or opinions are necessary to assist the court in understanding complex issues. These experts can include child psychologists, social workers, forensic accountants, or custody evaluators. Their role is to provide professional assessments, evaluations, or expert testimony relevant to the case.

Mediators: In cases where parties seek alternative dispute resolution, mediators may be involved. Mediators are neutral third parties who facilitate negotiations and assist the parties in reaching mutually acceptable agreements. They help parties explore options, communicate effectively, and work towards resolving conflicts outside of the courtroom.

Law Enforcement: In certain situations, law enforcement personnel may be involved in Family Court cases, particularly in cases of domestic violence or violations of court orders. Law enforcement officers may serve subpoenas or protective orders, ensure compliance with court directives, or provide security during court proceedings.

Guardian ad Litem: In some Family Court cases, a guardian ad litem may be appointed by the court. This individual serves as the legal representative for the best interests of a child or children involved in the case. The guardian ad litem conducts investigations, interviews relevant parties, and provides recommendations to the court regarding the child's welfare and interests.

Court-Appointed Evaluators: In complex cases, the court may appoint evaluators, such as forensic psychologists or social workers, to assess specific issues or provide expert opinions. These evaluators gather information, conduct assessments, and provide reports to the court, assisting in determining custody arrangements, visitation schedules, or other relevant matters.

Family Court Services Personnel: Family Court Services personnel are professionals employed by the court system who assist parties in resolving disputes related to child custody and visitation. They may conduct investigations, provide mediation services, and make recommendations to the court regarding custody and visitation arrangements that serve the best interests of the child.

Witnesses: Witnesses play a crucial role in Family Court cases by providing testimony or evidence relevant to the issues at hand. Witnesses may include family members, friends, neighbors, or professionals who can testify about the parties' behaviors, relationships, or specific events. Their statements can contribute to the court's understanding of the case and influence its decisions.

Interpreters: In cases where parties or witnesses have limited proficiency in the language used in the court proceedings, interpreters may be involved. Interpreters assist in ensuring effective communication between the parties, witnesses, and the court by providing accurate translations of spoken or written information.

Family Court Clerks: Family Court clerks are responsible for managing the administrative aspects of the court proceedings. They maintain case files, process paperwork, schedule hearings, and provide assistance to litigants regarding procedural matters, court forms, and filings. Family Court clerks play a vital role in ensuring the smooth operation of the court process.

Community Resources: In Family Court cases, parties may also engage community resources and services such as counselors, therapists, or social service agencies. These resources provide support, guidance, and counseling to the parties involved, particularly in cases where issues such as child abuse, domestic violence, or substance abuse are present.

Court-Appointed Special Advocates (CASAs): In some jurisdictions, Court-Appointed Special Advocates (CASAs) may be assigned to cases involving children who are victims of abuse or neglect. CASAs are trained volunteers who act as advocates for the child's best interests. They conduct investigations, monitor the child's situation, and provide recommendations to the court regarding the child's welfare and placement.

Family Court Coordinators: Family Court coordinators are professionals who assist the court in managing and coordinating cases, particularly those involving high conflict or complex issues. They help facilitate communication, develop parenting plans, and ensure compliance with court orders. Family Court coordinators play a crucial role in promoting cooperation and effective resolution of disputes.

Parenting Coordinators: Parenting coordinators are professionals appointed by the court to help parties in high-conflict custody disputes develop and implement parenting plans. They assist in resolving conflicts, improving communication, and facilitating the implementation of court-ordered parenting arrangements. Parenting coordinators aim to minimize conflict and promote the best interests of the children involved.

Advocacy Organizations: Various advocacy organizations and nonprofits provide support, resources, and legal assistance to individuals involved in Family Court cases. These organizations specialize in areas such as domestic violence, child advocacy, or family law, and may offer counseling, legal representation, or educational programs to parties navigating the Family Court system.

Probation Officers: In cases involving probation, such as those related to juvenile delinquency or parental supervision, probation officers may be involved. These officers monitor compliance with court-ordered conditions, supervise rehabilitative programs, and provide reports to the court regarding the progress and compliance of the individuals under their supervision.

Law Enforcement Liaisons: Law enforcement liaisons may be designated to facilitate communication and cooperation between Family Court and law enforcement agencies. They assist in enforcing court orders, ensuring compliance with protective orders, and addressing safety concerns in cases involving domestic violence or other criminal matters.

Child Welfare Agencies: In cases where child abuse, neglect, or dependency is alleged, child welfare agencies, such as child protective services, may be involved. These agencies investigate allegations, assess the safety and well-being of children, and provide recommendations to the court regarding the need for protective services, foster care, or reunification plans.

Appellate Courts: In the event of an appeal, appellate courts review decisions made by the Family Court. Appellate court judges and clerks review the case record, legal arguments, and briefs filed by the parties. They may affirm, reverse, or modify the lower court's decision based on the application of relevant law and legal principles.

### Types of Documents and Filings

In United States Family Court, various documents and filings play a crucial role in the judicial process and the litigation of a case. These documents serve to initiate legal actions, present arguments, provide evidence, and ensure that the court has a comprehensive record of the proceedings. Below is an inventory of the types of documents and filings commonly associated with Family Court cases, along with brief descriptions for each one:

Complaint/Petition: The complaint or petition is the initial document filed with the court to initiate a Family Court case. It outlines the legal claims, requests for relief, and the basis for the court's jurisdiction. This document sets forth the party's position and seeks the court's intervention to resolve the issues at hand.

Summons: The summons is a document issued by the court and served to the opposing party, notifying them of the legal action filed against them. It provides information about the lawsuit, the required response within a specified timeframe, and the consequences of failing to respond.

Answer/Response: The answer or response is the document filed by the defendant/respondent in response to the complaint or petition. It addresses the allegations made by the opposing party, presents the defendant's position, and may assert counterclaims or affirmative defenses.

Motion: A motion is a written request submitted to the court seeking a specific action or ruling. In Family Court, various types of motions may be filed, such as motions for temporary orders, motions to compel discovery, motions for modification of orders, or motions to dismiss. Motions must articulate legal arguments and provide supporting evidence or legal authority.

Affidavit: An affidavit is a written statement made under oath or affirmation, typically submitted as evidence in support of a motion, petition, or response. Affidavits may contain factual information, witness testimonies, or expert opinions relevant to the Family Court case.

Financial Affidavit: In cases involving child support, spousal support, or property division, parties may be required to file a financial affidavit. This document provides a comprehensive overview of the party's financial status, including income, assets, liabilities, expenses, and other relevant financial information.

Parenting Plan/Custody Agreement: In child custody cases, parties may submit a parenting plan or custody agreement outlining the proposed arrangements for the care, custody, and visitation of the child. These documents detail parenting schedules, decision-making authority, and other relevant provisions to establish a framework for co-parenting.

Order: An order is a document issued by the court that sets forth a decision or ruling on a specific matter. Family Court orders can cover a wide range of issues, including child custody, child support, visitation schedules, restraining orders, property division, or spousal support. Orders are binding and enforceable by law.

Discovery Requests and Responses: Discovery refers to the process through which parties obtain relevant information and evidence from each other. Discovery requests, such as interrogatories, requests for production of documents, or requests for admissions, are used to gather information. Responses to these requests must be provided in a timely manner and may be subject to court oversight.

Settlement Agreement/Stipulation: A settlement agreement or stipulation is a written agreement between the parties resolving some or all of the disputed issues in the Family Court case. This document outlines the terms agreed upon, such as child custody, visitation, support, and property division. Once approved by the court, it becomes a binding contract.

Pleadings: Pleadings are formal written statements filed by the parties that outline their respective claims, defenses, and legal positions. This includes the initial complaint or petition, as well as subsequent filings, such as amended pleadings or replies to counterclaims.

Supporting Documents: Supporting documents are materials that parties submit to provide evidence and support their claims or defenses. These documents can include financial records, medical records, school records, employment records, correspondence, photographs, or other relevant materials to substantiate their arguments.

Witness Statements: Witness statements are written statements provided by individuals with firsthand knowledge or relevant information pertaining to the Family Court case. These statements may be obtained through interviews or depositions and are used to present testimony when the witness cannot appear in court.

Expert Reports: In complex Family Court cases, parties may rely on expert witnesses to provide specialized knowledge or opinions on specific issues. Expert reports are written documents prepared by these experts, detailing their findings, analyses, and conclusions relevant to the case.

Notice of Hearing: A notice of hearing is a document that informs the parties involved of the date, time, and location of a scheduled court hearing or proceeding. It serves as official notification, allowing the parties to prepare and attend the hearing accordingly.

Subpoenas: Subpoenas are legal documents issued by the court or parties involved, compelling the attendance of witnesses or the production of specific documents or evidence. Subpoenas may be used to secure the presence of witnesses or to obtain records crucial to the case.

Pretrial Statements: Pretrial statements are documents submitted by the parties before a trial or hearing, summarizing the facts, issues, and legal arguments to be presented. These statements help streamline the proceedings and ensure that all relevant matters are addressed during the trial.

Orders to Show Cause: Orders to show cause are court directives that require a party to appear in court and explain why specific actions should or should not be taken. These orders may be issued when there are urgent matters or when the court needs further information or clarification from the parties.

Transcripts: Transcripts are verbatim records of court proceedings, including hearings, trials, or depositions. Transcripts serve as an official record of the proceedings and can be used for reference or review during the litigation process or for future appeals.

Judgments and Decrees: Judgments and decrees are final rulings issued by the court at the conclusion of a Family Court case. They outline the court's decision on the issues in dispute, such as divorce, child custody, support, or property division. Judgments and decrees are legally binding and dictate the rights and obligations of the parties involved.

It's important to note that this is not an exhaustive list, as Family Court cases can vary significantly in complexity and specific requirements based on the jurisdiction and nature of the case. Additionally, local rules and court procedures may introduce additional documents or filings.

### Legal Chat Bot

In one embodiment the CRAEML may implement a legal chat bot, a powerful tool designed to enhance user experience and provide a user with immediate support and assistance. Below are some exemplary features of the legal chat bot:
1. Instant Support, Anytime, Anywhere: With our legal chat bot, you no longer have to wait for office hours or rely on email correspondence to get your questions answered. Our chat bot is available 24/7, providing you with instant support and guidance whenever you need it, at your convenience.
2. Quick and Efficient Information Retrieval: Our chat bot is equipped to swiftly retrieve the information you need. Whether you have a common legal question or require access to legal resources, our chat bot can provide you with immediate answers, relevant articles, frequently asked questions, and other resources, saving you time and effort.
3. Personalized Assistance and Engagement: We understand the importance of personalized service. Our chat bot engages in interactive conversations, allowing you to ask follow-up questions and receive tailored responses. This personalized interaction ensures that your specific needs are understood and addressed effectively.
4. Initial Case Assessment and Guidance: Our chat bot can assist you in the initial assessment of your case. By collecting relevant details and information about your legal issue, our chat bot can direct you to the appropriate legal services within the firm, ensuring you receive the support you need from the right lawyers or departments.
5. Empowerment and Self-Service Options: We believe in empowering our users. Our chat bot provides self-service options, allowing you to access legal information, review resources, and explore various legal topics on your own. This self-service capability puts you in control of your legal journey, offering convenience and flexibility.
6. Enhanced Efficiency and Productivity: By automating routine inquiries and offering self-service options, our chat bot increases efficiency and productivity for both the attorney and the firm. You can obtain immediate assistance without waiting for human staff, while our legal professionals can focus on more complex and specialized tasks, ensuring you receive the highest quality service.
7. Cost-Effective and Affordable Solutions: We understand that cost is an important consideration. Our chat bot provides you with legal information and guidance at a lower cost or free of charge, reducing the use of in-person or phone consultations. This cost-effectiveness makes legal assistance more accessible and affordable for you.

We are committed to enhancing your experience and providing you with exceptional service. Our legal chat bot is designed to streamline processes, offer immediate support, and empower you in your legal journey. Experience the benefits of our legal chat bot today and discover a more accessible and user-friendly way to engage with the firm.

### Legal Chat Bot: Streamlining Client Intake, Vetting, and Conflict Clearance

Below are some exemplary benefits of utilizing a legal chat bot for client intake, vetting, and clearing of conflicts that provides an overview of how the legal chat bot can optimize these processes.

### Client Intake

The legal chat bot serves as an efficient tool for client intake, simplifying the initial information gathering process. By engaging in automated conversations with potential clients, the chat bot collects pertinent details about their legal issues. It utilizes a series of predefined questions to extract information such as the nature of the problem, parties involved, and important dates or deadlines. This automated intake process ensures accuracy and efficiency in capturing information.

### Vetting and Qualification

Through its ability to assess predefined criteria, the legal chat bot streamlines the vetting and qualification of potential clients. Based on the responses received, the chat bot evaluates whether the client's case aligns with the firm's expertise, practice areas, or specific criteria. Factors such as jurisdiction, legal complexity, and potential conflicts of interest may be considered. This automated vetting process enables determining if the client's needs can be effectively addressed by the firm.

### Conflict Clearance

Clearing conflicts of interest is a crucial step in maintaining ethical representation. The legal chat bot may contribute to this process by collecting information from potential clients, including the names of individuals or organizations involved in the case. Using this information, the chat bot cross-references existing client and case databases to identify any potential conflicts. If a conflict arises, the chat bot promptly notifies the relevant personnel within the firm for further review and resolution.

### Benefits of Utilizing A Legal Chat Bot

Efficiency and Accuracy: The automated nature of the chat bot ensures a consistent and thorough intake process, minimizing the risk of human error and allowing for prompt data collection and analysis.

Time and Resource Savings: By automating initial stages of client intake, vetting, and conflict clearance, the chat bot liberates valuable time for paralegals and legal aides to focus on more complex tasks. This leads to increased efficiency and productivity within the firm.

Consistency and Compliance: The chat bot applies predefined criteria consistently, ensuring that potential clients go through the same vetting process. It helps uphold ethical and regulatory obligations by systematically identifying and addressing conflicts of interest.

Improved Client Experience: Clients benefit from a streamlined intake process, as the chat bot provides immediate responses and guides them through the initial stages efficiently. This enhances client satisfaction and reduces waiting times.

Confidentiality and Security: Legal chat bots can be programmed to prioritize data privacy and security. They adhere to strict confidentiality protocols, safeguarding sensitive client information.

Utilizing a legal chat bot enhances the firm's operational efficiency, accuracy, compliance, and client satisfaction. By streamlining client intake, vetting, and conflict clearance processes, paralegals and legal aides can better allocate their time and resources to higher-value tasks, ultimately contributing to the success of the firm.

### Comprehensive Approach to Collecting and Analyzing Public Records, Filings, and Information in Legal Matters and Cases

In one embodiment, a comprehensive approach to collect and analyze public records, filings, and information related to legal matters and Court Cases may be utilized. This facilitates educating and informing expert lawyers, legal aids, and paralegals. Below are exemplary technologies and strategies that may be employed for data collection, ingestion, analysis, and tagging to make the data searchable and usable. Additionally, the analysis of the large volume of information to identify patterns and assess alignment with applicable laws and regulations is addressed.

### Data Collection and Ingestion

To collect and ingest data from various sources, a combination of manual and/or automated approaches may be utilized. These may include:

Public Records Databases: Leverage publicly available databases and repositories specific to the legal matter, court case, and/or negotiation to gather structured data, such as court dockets, case summaries, and judgments. This information can be obtained from online court portals, government websites, and legal research platforms.

Court Filings and Documents: Procedures to systematically retrieve court filings and documents from relevant jurisdictions. In various embodiments, this may involve accessing court websites, subscribing to electronic filing services, or partnering with data providers specializing in court records.

Web Scraping: In cases where data is not readily available through official channels, web scraping techniques to extract information from websites, legal forums, news outlets, and other online sources may be employed. Compliance with legal and ethical guidelines while performing web scraping activities is ensured.

API Integration: Integrate with APIs provided by legal research platforms, court systems, or data aggregators to retrieve structured data efficiently. This approach can provide access to comprehensive and up-to-date information on legal matters, court cases, and/or negotiations.

### Analysis Of Structured and Unstructured Data

Once the data is collected and ingested, advanced analytical techniques may be employed to gain insights and extract valuable information. The analysis may involve processing both structured and/or unstructured data using the following exemplary technologies:

Data Warehousing: Utilize a centralized data repository or data warehouse to store and manage the collected data. This may facilitate efficient data retrieval, integration, and analysis.

Natural Language Processing (NLP): NLP techniques may be utilized to process unstructured data such as court judgments, case summaries, legal opinions, and other textual information. NLP algorithms can extract key entities, perform sentiment analysis, and categorize text to enable effective search and retrieval.

Machine Learning (ML): ML algorithms may be utilized in categorizing, classifying, and clustering the structured and unstructured data. ML models may be trained to identify patterns, predict case outcomes, and assess the applicability of laws and regulations specific to the legal matter, court case and/or negotiation.

Text Analytics: Text analytics tools may be employed to extract key insights from textual data. Named entity recognition, topic modeling, and sentiment analysis techniques can aid in understanding the context and sentiment associated with the legal matter, court case and/or negotiation.

### Tagging and Labeling for Searchability

To make the collected data searchable and usable, a comprehensive tagging and labeling strategy may be utilized. This may involve:

Metadata Enrichment: Enhance the collected data with relevant metadata, including case numbers, court names, filing dates, parties involved, case types, and other pertinent information. This metadata may enable efficient searching, filtering, and categorization of the data.

Automated Tagging: Using AI-powered techniques, automatically tag and/or label the data based on predefined categories, such as case types, legal issues, jurisdictions, and relevant statutes. This automated tagging process may be achieved through the use of machine learning algorithms and natural language processing techniques. By training models on a labeled dataset, the assignment of relevant tags to each case, document, or piece of information may be automated. This may streamline the organization and retrieval of data, allowing a user to quickly locate specific information based on different criteria.

Manual Tagging and Validation: In some embodiments, some cases may utilize manual tagging and validation by legal professionals. This ensures accuracy and precision in categorizing complex legal concepts, nuanced issues, and specific case details. Paralegals and legal aids may carefully review and/or tag the data to ensure its integrity and relevance.

Analysis of Large Volume of Information

With the vast amount of data collected, an efficient approach to analyze and extract meaningful insights may be utilized. The following techniques may be employed:

Data Mining and Pattern Recognition: Employ data mining techniques to identify patterns, trends, and relationships within the collected data. This may enable uncovering valuable insights, such as common legal strategies, precedents, successful arguments, or emerging issues in the legal matter, court case and/or negotiation.

Statistical Analysis: Statistical analysis may be applied to quantify and interpret data, allowing identification of significant correlations, evaluation of the impact of variables, and measurement of the effectiveness of legal arguments or strategies.

Visualization Techniques: Utilizing data visualization tools and/or techniques, complex information may be presented in a clear and intuitive manner. Interactive charts, graphs, and dashboards may facilitate the communication of key findings, enabling a user to quickly grasp trends, outliers, and important case dynamics.

Regulatory Compliance Assessment: The alignment of the collected data with applicable laws and regulations in the legal matter, court case and/or negotiation may be assessed. This may involve cross-referencing case information with relevant statutes, court rules, and legal precedents to ensure compliance and accuracy in analyses.

### Online Resources by State

Below is a list of state court websites and online sources for searching court documents in each state in the United States:
Alabama: alacourt.gov
Alaska: courts.alaska.gov
Arizona: azcourts.gov
Arkansas: courts.arkansas.gov
California: courts.ca.gov
Colorado: courts.state.co.us
Connecticut: jud.ct.gov
Delaware: courts.delaware.gov
Florida: flcourts.org
Georgia: georgiacourts.gov
Hawaii: courts.state.hi.us
Idaho: isc.idaho.gov
Illinois: illinoiscourts.gov
Indiana: courts.in.gov
Iowa: iowacourts.gov
Kansas: kscourts.org
Kentucky: kycourts.gov
Louisiana: lasc.org
Maine: courts.maine.gov
Maryland: mdcourts.gov
Massachusetts: mass.gov/courts
Michigan: courts.michigan.gov
Minnesota: mncourts.gov
Mississippi: courts.ms.gov
Missouri: courts.mo.gov
Montana: courts.mt.gov
Nebraska: supremecourt.nebraska.gov
Nevada: nvcourts.gov
New Hampshire: courts.state.nh.us
New Jersey: njcourts.gov
New Mexico: nmcourts.gov
New York: nycourts.gov
North Carolina: nccourts.gov
North Dakota: . ndcourts.gov
Ohio: sc.ohio.gov
Oklahoma: www.oscn.net
Oregon: courts.oregon.gov
Pennsylvania: pacourts.us
Rhode Island: courts.ri.gov
South Carolina: sc.gov/courts
South Dakota: ujs.sd.gov
Tennessee: tncourts.gov
Texas: txcourts.gov
Utah: utcourts.gov
Vermont: vermontjudiciary.org
Virginia: vacourts.gov
Washington: courts.wa.gov
West Virginia: wvcourts.gov
Wisconsin: wicourts.gov
Wyoming: courts.state.wy.us

### Additional Craeml Embodiments

The “Respondent Centric Information Collection System” (RCICS) enhances the CRAEML system by introducing a more user-centric approach to data collection, making it a potent tool for legal professionals. Adding the “Respondent Centric Information Collection” service as an embodiment within the CRAEML:

Embodiments of the CRAEML may also comprise a Respondent Centric Information Collection System (RCICS) designed to capture the opinions and preferences of individuals by utilizing artificial intelligence, aiming to curate a personalized and engaging user experience. The RCICS seeks to foster a sense of community, trust, and authentic belonging, placing users at the core of its operations.

Additionally, the RCICS employs social graphing techniques for peer-to-peer information collection, thereby enhancing the richness of data collected. The system is designed to convert personal data and preferences into attitudinal and sentiment data, which can be further utilized to provide system awareness and manage initiatives at scale across communities, cohorts, and clusters.

The RCICS provides a unique method for collecting personal, attitudinal, and sentiment data, allowing for the creation of real-time profiles for each respondent. This offers a highly tailored and dynamic user experience while promoting effective data collection and analysis. This approach is designed to assist organizations in better understanding and engaging their user base. Distinctive aspects of the RCICS may include:
0170.1. Personalized Engagement: The system creates highly personalized user experiences by employing a peer-to-peer acquisition model and UX/UI with language tailored for each user.
0170.2. Issue-Focused Approach: The system focuses on ‘hot button’ issues of high interest and importance to users.
0170.3. Extensive Reach: The system leverages the peer-to-peer acquisition model and integrates with leading social media and messaging platforms, thereby enhancing reach and engagement opportunities.
0170.4. Data Collection and Analysis: The system ensures data integrity, accuracy, and timeliness, while conducting real-time analysis to identify clusters/communities, critical events, and situations that call for priority responses.

Furthermore, the RCICS can be integrated with other CRAEML components for enhanced capabilities including:
0171.1. User-Centric Experience: Customized interactions based on collected and analyzed user preferences and opinions.
0171.2. Advanced Data Capture & Analytics: AI-driven identification and understanding of attitudinal and sentiment information.
0171.3. Personalized Interfaces and UX/UI: Enhanced user engagement through tailored interfaces and interactions.
0171.4. Robust Data Management: Ensured data integrity, confidentiality, and accuracy.

The RCICS may also be employed in various use cases such as the Family Court Project, Healing Centered Workplace, and Perceptions in Politics, demonstrating its potential for versatility and applicability in diverse domains. Additional use cases include Data and Technology, Pharmaceutical Patent Impact, Financial Inclusion, New Era of Financial Compliance, Gender Dynamics, etc.

Comprehensive Data Analysis: The RCICS enables data analysts to make informed decisions and predictions based on real-time analytics, AI-enabled insights, and historical attribute analysis. This extends the capabilities of the CRAEML by offering a more detailed view of the respondent's behavioral patterns and preferences.

Community Mapping & Management: Identifies and manages communities, cohorts, and clusters based on respondents' activities and interests. This enhances the understanding of the user base, enabling more effective resource allocation and engagement strategies.

Integration with Social Media Platforms: The RCICS integrates seamlessly with leading social media and messaging platforms to facilitate respondent engagement and data collection. This broadens the reach and accessibility of the CRAEML, allowing it to more effectively gather and process data.

Future Needs Analysis: The RCICS enables participants to communicate future needs, understanding the urgency and time sensitivity of the need, and facilitates connections with like-minded individuals or experts. This can be especially useful in legal proceedings, where needs can shift rapidly.

Real-Time Predictive Modeling: The system provides respondents with real-time predictive modeling based on their data, enabling proactive responses. This extends the predictive capabilities of the CRAEML, allowing it to anticipate respondent behavior and tailor its responses accordingly.

Data Normalization & Structuring: The RCICS enables the collection, normalization, and structuring of data for use by models and authorized participants. This ensures that data collected is not only accurate, but also in a format that can be effectively utilized by the CRAEML system.

Family Court Project: By engaging with impacted litigants to gather their data, the RCICS and CRAEML can identify legal professionals, court officers, therapists, and others engaged in criminal activities, thereby improving the efficiency and efficacy of the court systems.

Healing Centered Workplace: Working with employers to gather employee attitudinal and sentiment data, the combined system can track trends over time, potentially leading to improvements in workplace environment and practices.

Perceptions in Politics: By engaging with registered voters to understand perceptions on specific issues, identify communities and clusters, and track changes in behavior, the RCICS can provide valuable insights for political campaigns and policy makers.

Direct to User: The RCICS directly engages with individuals impacted using peer-to-peer engagement and trusted intermediaries. This user-centric approach can provide more accurate and authentic data, enhancing the capabilities of the CRAEML system in processing and managing this data effectively.

Direct to Employee: By partnering with corporations to provide tools for information gathering and analytics, the RCICS creates a trustworthy engagement experience for employees. The data gathered through this method can provide valuable insights into the workplace, augmenting the capabilities of the CRAEML system when dealing with cases related to employment law and corporate policies.

The CRAEML may incorporate several additional embodiments for optimal performance. These include an Enhanced Data Security Mechanism for robust data protection, a Responsive User Interaction Module for seamless user experience, a Scalable Data Processing Apparatus for managing large volumes of data, a Robust Error Handling Mechanism for system resilience, a Compatibility Interface Module for cross-platform accessibility, and a Data Integrity Assurance Apparatus for ensuring the quality and reliability of the collected data. Together, these embodiments ensure a highly secure, scalable, and user-friendly system that guarantees data integrity.

Enhanced Data Security Mechanism: An embodiment of the CRAEML comprises an Enhanced Data Security Mechanism, ensuring that data collected through intake forms is kept secure. This mechanism incorporates advanced encryption techniques, secure transfer protocols, and adherence to industry-standard data protection principles, rendering a comprehensive security layer safeguarding user-provided information against unauthorized access.

Responsive User Interaction Module: CRAEML features a Responsive User Interaction Module, designed to provide real-time feedback to the user during form completion. This module promptly reflects changes, validates form data, and provides updates on form status to ensure an efficient and engaging user experience.

Scalable Data Processing Apparatus: CRAEML equips a Scalable Data Processing Apparatus, enabling the system to effectively manage a wide range of form submission volumes. This apparatus adopts state-of-the-art techniques to support potential growth in form submissions while maintaining high performance.

Robust Error Handling Mechanism: CRAEML implements a Robust Error Handling Mechanism. This mechanism empowers the system to handle invalid data inputs, system errors, or unexpected user actions effectively, ensuring system resilience and graceful recovery to preserve ongoing operations.

Compatibility Interface Module: CRAEML incorporates a Compatibility Interface Module, making it compatible with various devices and platforms. This module allows users to access and submit intake forms through any internet-enabled device, increasing the accessibility of the system.

Data Integrity Assurance Apparatus: CRAEML features a Data Integrity Assurance Apparatus. This apparatus guarantees the quality and reliability of the collected data, upholding its accuracy, consistency, and reliability during storage and processing.

Context-Aware Features of the Respondent Centric Information Collection System (RCICS): The RCICS introduces advanced Context-Aware Capabilities designed to dynamically adapt the user interface and interaction based on the user's immediate context, historical interactions, and derived preferences. These features facilitate creating a personalized and engaging user experience that responds to the evolving needs and behaviors of users.

Dynamic Interface Adaptation: The system utilizes advanced algorithms to modify the UI/UX in real-time, tailoring the display and available options based on the user's past behaviors, current needs, and possible future actions. This adaptive interface supports a seamless and intuitive interaction, significantly enhancing user engagement.

Feedback-Driven Interface Refinement: Continuously capturing user feedback, both explicit and inferred from user interactions, the RCICS refines and adjusts the interface dynamically. This ongoing learning process allows the system to become increasingly effective in meeting user needs and preferences.

Enhanced Personalization through AI: By integrating artificial intelligence, the system analyzes real-time data to offer personalized greetings, content, responses, and recommendations. This AI-driven personalization ensures that each user interaction is relevant and uniquely tailored, enhancing the overall user experience.

Contextual Data Integration: The system intelligently incorporates contextual information, such as location, time of day, and recent user activities, to provide relevant options and services. This capability ensures that the system's responses are appropriate to the current context of the user, increasing the efficacy and appropriateness of the interactions.

Multi-Turn Conversation Handling: Employing advanced natural language processing techniques, the RCICS supports complex, multi-turn conversations that maintain the context over extended interactions. This feature allows users to engage in more natural and effective dialogues with the system, mirroring human-like conversation patterns over a specific or extensive timeframes.

Proactive Interaction and Predictive Assistance: The system anticipates user needs based on historical data and current interaction trends. By predicting user requests before they are explicitly made, the RCICS can offer proactive assistance, thereby enhancing user satisfaction and system usability.

Security Enhancements for User Data: Integrating robust security measures, the RCICS ensures that user data collected during interactions is securely handled. The use of encryption and tokenization protects personal information from unauthorized access and ensures compliance with data protection regulations.

Error Handling and Adaptive Responses: The system is equipped with sophisticated error-handling capabilities that detect, log, and/or respond to user input errors and/or system faults. Adaptive responses help guide the user back on track without breaking the interaction flow, thereby maintaining engagement and trust.

Implementation Across Diverse Platforms: The RCICS is designed to be platform-agnostic, providing consistent and responsive user experiences across various digital interfaces, including mobile, web, and embedded systems. This cross-platform compatibility ensures that users have a seamless experience regardless of the device or platform used.

Advanced Encryption and Tokenization for Anonymity and Data Privacy: The RCICS employs state-of-the-art encryption and tokenization technologies to ensure that responses can be processed in a de-identified and anonymous manner. By converting sensitive user data into a non-identifiable format before processing and storage, the system upholds stringent data privacy standards. This approach not only protects the identity and privacy of users but also enables the system to handle sensitive data without compromising security. The tokenization process replaces personal identifiers with unique tokens, which are then used within the system to handle data in a way that is anonymous but still useful for analysis and personalization. These security measures facilitate maintaining user trust and compliance with global data protection regulations, such as GDPR and HIPAA, providing users with confidence that their interactions and data are handled with the utmost security and confidentiality.

Real-Time and Ongoing Contextual and Data Analytics: The RCICS is equipped with advanced analytical capabilities that allow for the continuous and real-time monitoring and analysis of respondent interactions and data. This system is designed to perform in-depth contextual analytics that capture and analyze responses not only at a single point in time but also across extended periods and sequences of events. By employing sophisticated data analytics algorithms, the system can track, record, and/or analyze time-series data, enabling stakeholders to observe trends, patterns, and anomalies over any specified timeframe. This capability allows for dynamic adjustments in strategies or interventions based on evolving data insights, enhancing the system's ability to respond to changes in user behavior, sentiment, and engagement. The inclusion of time-series analysis supports comprehensive longitudinal studies and detailed behavior tracking, which are critical for making informed decisions and optimizing interactions and outcomes continuously.

Comprehensive Multi-Level and Geographical Analytics Capabilities: The RCICS not only provides detailed analytics at the individual respondent level but also extends its analytical capabilities to groups, organizations, institutions, and/or affiliations. This multifaceted approach allows for contextually relevant analytics that encompass broader collective entities, enhancing the understanding of dynamics within and between these groups. Additionally, the system is equipped to conduct analyses across different geographical and jurisdictional boundaries, from local addresses and campuses to cities, counties, provinces, states, and nations. This geographical versatility enables the system to perform cross-location analyses, providing insights into how individuals and groups interact with and relate to different environments and regulatory contexts. By correlating data across these diverse entities and locations, the RCICS offers a robust framework for understanding complex relational dynamics and environmental influences, facilitating targeted strategies and decisions that are finely tuned to the specific characteristics of each group, location, and/or jurisdiction.

### CRAEML

FIG. 1 shows non-limiting, example embodiments of an architecture for the CRAEML. In FIG. 1, an embodiment of an illustrative technical architecture that may be utilized to facilitate CRAEML operation is illustrated. In various embodiments, the architecture may implement the following features:
1. DATA COLLECTION: APIs, UX/UI, and services enabling a respondent to submit data associated with an initiative movement, advocacy, or related service
2. USER & DATA VERIFICATION: Assertion Based Digital Identity (ABDI) verification of respondents, data validation at time of input (e.g., SSN), integrated verification services for checking of data against best-in-class third party services
3. DATA ANALYTICS: Orchestration of integrated analytics service enabling initial triage, automated analysis of structured, semi-structured, and unstructured data; generation of alerts and events based on results of analysis
4. EVENTS & ALERTING: Rules based management of events/alerts based on data collected, results of analysis, and results of identity and data verification with a focus on supporting Impact Initiatives and Movements that Measure as well as other services
5. DATA & USER MONITORING: Conduct ongoing screens and checks of users and submitted data based upon monitoring rules and also established thresholds and criteria for invoking periodic checks
6. PROPRIETARY PROTOCOLS: Establishes ‘industry standard’ protocols for collection, verification, analysis, and alerting

In various embodiments, the architecture may provide the following benefits:
1. USER ACQUISITION: Generation of leads, acquiring leads and driving initial and ongoing engagement with users
2. DATA COLLECTION: Collection of data across corporate, individual, and social impact initiatives with easy to configure, deploy, and manage forms, APIs and configurable UX/UI
3. DATA & USER VERIFICATION: Automating the device fingerprinting, strong authentication of users and verification of data submitted by the respondent using best-in-class credit bureaus and services
4. DATA PROCESSING: Intake and processing of structured, semi-structured, and unstructured data for real-time verification and analysis
5. DATA MANAGEMENT WORKFLOW: Automating the rules, roles, routes for intake, verification, and analysis of data with a focus on enabling real-time triage and response as well as ongoing data use
6. PATTERN AND PROFILING: Enables use of NLP/MUAI for sophisticated pattern recognition and profiling
7. REPORTING AND ANALYTICS: Logging and tracking of data capture and analytics events to provide robust analysis of process efficiency as well as information utilized for oversight and examination

FIG. 2 shows non-limiting, example embodiments of a datagraph illustrating data flow(s) for the CRAEML. In FIG. 2, a client 202 (e.g., of a user) may send a matter milestone interaction input (e.g., comprising a milestone document (e.g., a controversy document such as a proposed custody agreement associated with a family law case, an offer document such as a licensing agreement offer associated with an invention)) 221 to a CRAEML server 206 to facilitate generating a resolution document (e.g., a response to the milestone document). For example, the client may be a desktop, a laptop, a tablet, a smartphone, a smartwatch, and/or the like that is executing a client application. In one implementation, the matter milestone interaction input may include data such as a request identifier, a user identifier (e.g., a client_id), a case identifier, a document identifier, a document type, document content, and/or the like. In one embodiment, the client may provide the following example matter milestone interaction input, substantially in the form of a (Secure) Hypertext Transfer Protocol (“HTTP(S)”) POST message including extensible Markup Language (“XML”) formatted data, as provided below:

```
POST /authrequest.php HTTP/1. 1
Host: www.server.com
Content-Type: Application/XML
Content-Length: 667
<?XML version = ″1.0″ encoding = ″UTF-8″?>
<auth_request>
  <timestamp>2020-12-31 23:59:59</timestamp>
  <user_accounts_details>
    <user_account_credentials>
      <user_name>JohnDaDoeDoeDoooe@gmail.com</user_name>
      <password>abc123</password>
      //OPTIONAL <cookie>cookieID</cookie>
      //OPTIONAL <digital_cert_link>www.mydigitalcertificate.com/
JohnDoeDaDoeDoe@gmail.com/mycertifcate.dc</digital_cert_link>
      //OPTIONAL <digital_certificate>_DATA _</digital_certificate>
    </user_account_credentials>
  </user_accounts_details>
  <client_details> //iOS Client with App and Webkit
      //it should be noted that although several client details
      //sections are provided to show example variants of client
      //sources, further messages may include only one to save
      //space
    <client_IP>10.0.0.123</client_IP>
    <user_agent_string>Mozilla/5.0 (iPhone; CPU iPhone OS 7_1_1 like Mac OS
X) AppleWebKit/537.51.2 (KHTML, like Gecko) Version/7.0 Mobile/ 11D201
Safari/9537.53</user_agent_string>
    <client_product_type>iPhone6, 1</client_product_type>
    <client_serial_number>DNXXX1X1XXXX</client_serial_number>
    <client_UDID>3XXXXXXXXXXXXXXXXXXXXXXXXD</client_UDID>
    <client_OS>iOS</client_OS>
    <client_OS_version>7.1.1</client_OS_version>
    <client_app_type>app with webkit</client_app_type>
    <app_installed_flag>true</app_installed_flag>
    <app_name>CRAEML.app</app_name>
    <app_version>1.0 </app_version>
    <app_webkit_name>Mobile Safari</client_webkit_name>
    <client_version>537.51.2</client_version>
  </client_details>
  <client_details> //iOS Client with Webbrowser
      <client_IP>10.0.0.123</client_IP>
      <user_agent_string>Mozilla/5.0 (iPhone; CPU iPhone OS 7_1_1 like Mac OS
X) AppleWebKit/537.51.2 (KHTML, like Gecko) Version/7.0 Mobile/11D201
Safari/9537.53</user_agent_string>
      <client_product_type>iPhone6, 1</client_product_type>
      <client_serial_number>DNXXX1X1XXXX</client_serial_number>
      <client_UDID>3XXXXXXXXXXXXXXXXXXXXXXXXD</client_UDID>
      <client_OS>iOS</client_OS>
      <client_OS_version>7.1.1</client_OS_version>
      <client_app_type>web browser</client_app_type>
      <client_name>Mobile Safari</client_name>
      <client_version>9537.53</client_version>
  </client_details>
  <client_details> //Android Client with Webbrowser
      <client_IP>10.0.0.123</client_IP>
      <user_agent_string>Mozilla/5.0 (Linux; U; Android 4.0.4; en-us; Nexus
S Build/IMM76D) AppleWebKit/534.30 (KHTML, like Gecko) Version/4.0 Mobile
Safari/534.30</user_agent_string>
    <client_product_type>Nexus S</client_product_type>
    <client_serial_number>YXXXXXXXXZ</client_serial_number>
    <client_UDID>FXXXXXXXXX-XXXX-XXXX-XXXX-XXXXXXXXXXXXX</client_UDID>
    <client_OS>Android</client_OS>
    <client_OS_version>4.0.4</client_OS_version>
    <client_app_type>web browser</client_app_type>
    <client_name>Mobile Safari</client_name>
    <client_version>534.30</client_version>
  </client_details>
  <client_details> //Mac Desktop with Webbrowser
      <client_IP>10.0.0.123</client_IP>
      <user_agent_string>Mozilla/5.0 (Macintosh; Intel Mac OS X 10_9_3)
  AppleWebKit/537.75.14 (KHTML, like Gecko) Version/7.0.3
  Safari/537.75.14</user_agent_string>
      <client_product_type>MacPro5,1</client_product_type>
      <client_serial_number>YXXXXXXXXZ</client_serial_number>
      <client_UDID>FXXXXXXXXX-XXXX-XXXX-XXXX-XXXXXXXXXXXXX</client_
      UDID>
      <client_OS>Mac OS X</client_OS>
      <client_OS_version>10.9.3</client_OS_version>
      <client_app_type>web browser</client_app_type>
      <client_name>Mobile Safari</client_name>
      <client_version>537.75.14</client_version>
  </client_details>
  <matter_milestone_interaction_input>
    <request_identifier>ID_request_1</request_identifier>
    <user_identifier>ID_user_1</user_identifier>
  <case_identifier>ID_case_1</case_identifier>
  <document_identifier>ID_controversy_document_1</document_identifier>
  <document_type>CUSTODY_AGREEMENT</document_type>
  <document_content>content (e.g., PDF file) of a proposed custody
agreement</document_content>
</matter_milestone_interaction_input>
</auth_request>
```

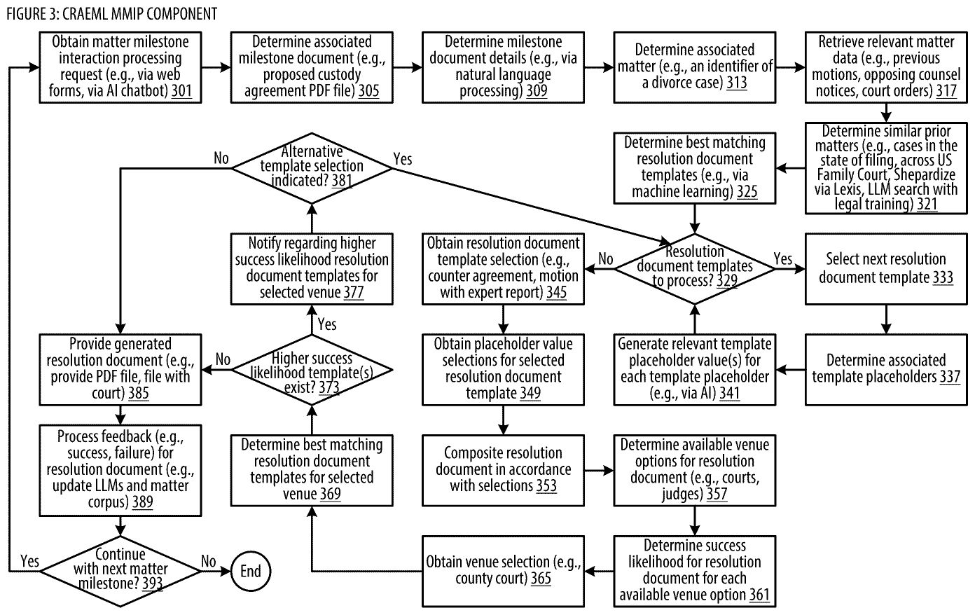

A matter milestone interaction processing (MMIP) component 225 may utilize data provided in the matter milestone interaction input to generate the resolution document (e.g., that addresses the milestone document). See FIG. 3 for additional details regarding the MMIP component.

The CRAEML server 206 may send a matter milestone (e.g., case data) request 229 to a repository 210 to retrieve relevant matter milestone data. In one implementation, the matter milestone request may include data such as a request identifier, query parameters, and/or the like. In one embodiment, the CRAEML server may provide the following example matter milestone request, substantially in the form of a HTTP(S) POST message including XML-formatted data, as provided below:

```
POST /matter_milestone_request.php HTTP/1.1
Host: www.server.com
Content-Type: Application/XML
Content-Length: 667
<?XML version = ″1.0″ encoding = ″UTF-8″?>
<matter_milestone_request>
  <request_identifier>ID_request_2</request_identifier>
  <query_parameters>
    <case_identifier>ID_case_1</case_identifier>
    <document_type>CUSTODY_AGREEMENT</document_type>
    <document_source>OPPOSING_PARTY</document_source>
    <document_date>1/2/2025</document_date>
    <document_references>ID_document_12, ID_document_34</
    document_references>
  </query_parameters>
</matter_milestone_request>
```

The repository 210 may send a matter milestone response 233 to the CRAEML server 206 with the requested relevant matter milestone data. In one implementation, the matter milestone response may include data such as a response identifier, the requested relevant matter milestone data, and/or the like. In one embodiment, the repository may provide the following example matter milestone response, substantially in the form of a HTTP(S) POST message including XML-formatted data, as provided below:

```
POST /matter_milestone_response.php HTTP/1.1
Host: www.server.com
Content-Type: Application/XML
Content-Length: 667
<?XML version = ″1.0″ encoding = ″UTF-8″?>
<matter_milestone_response>
  <response_identifier>ID_response_2</response_identifier>
  <case_data>
    <document>
      <document_identifier>ID_document_5</document_identifier>
      <document_type>MOTION</document_type>
      <document_content>document content (e.g., PDF file) </document_
      content>
    </document>
    <document>
      <document_identifier>ID_document_12</document_identifier>
      <document_type>COURT_ORDER</document_type>
      <document_content>document content (e.g., PDF file) </document_
      content>
    </document>
    ...
  </case_data>
</matter_milestone_response>
```

The CRAEML server 206 may send a resolution document templates request 237 to the repository 210 to retrieve best matching resolution document templates for the milestone document. In one implementation, the resolution document templates request may include data such as a request identifier, template identifiers, and/or the like. In one embodiment, the CRAEML server may provide the following example resolution document templates request, substantially in the form of a HTTP(S) POST message including XML-formatted data, as provided below:

```
POST /resolution_document_templates_request.php HTTP/1.1
Host: www.server.com
Content-Type: Application/XML
Content-Length: 667
<?XML version = ″1.0″ encoding = ″UTF-8″?>
<resolution_document_templates_request>
  <request_identifier>ID_request_3</request_identifier>
  <template_identifier>ID_resolution_document_template_1</template_
  identifier>
  <template_identifier>ID_resolution_document_template_2</template_
  identifier>
</resolution_document_templates_request>
```

The repository 210 may send a resolution document templates response 241 to the CRAEML server 206 with the requested resolution document templates. In one implementation, the resolution document templates response may include data such as a response identifier, the requested resolution document templates data, and/or the like. In one embodiment, the repository may provide the following example resolution document templates response, substantially in the form of a HTTP(S) POST message including XML-formatted data, as provided below:

```
POST /resolution_document_templates_response.php HTTP/1.1
Host: www.server.com
Content-Type: Application/XML
Content-Length: 667
<?XML version = ″1.0″ encoding = ″UTF-8″?>
  <resolution_document_templates_response>
  <response_identifier>ID_response_3</response_identifier>
  <template_data>
  <template_identifier>ID_resolution_document_template_1</template_
  identifier>
    <template_type>CUSTODY_AGREEMENT</template_type>
    <template_content>template content (e.g., text and
placeholders)</template_content>
  </template_data>
  <template_data>
  <template_identifier>ID_resolution_document_template_2</template_
  identifier>
    <template_type>MOTION</template_type>
    <template_subtype>EXPERT_REPORT</template_subtype>
    <template_content>template content (e.g., text and
placeholders)</template_content>
  </template_data>
</resolution_document_templates_response>
```

The CRAEML server 206 may send a template options selection request 245 to the client 202 to prompt the user to select values for resolution document template options (e.g., select which resolution document template to utilize, select placeholder values for a resolution document template (e.g., provided by the user, selected from AI generated values)). In one implementation, the template options selection request may include data such as a request identifier, template data, template options data, and/or the like. In one embodiment, the CRAEML server may provide the following example template options selection request, substantially in the form of a HTTP(S) POST message including XML-formatted data, as provided below:

```
POST /template_options_selection_request.php HTTP/1.1
Host: www.server.com
Content-Type: Application/XML
Content-Length: 667
<?XML version = ″1.0″ encoding = ″UTF-8″?>
<template_options_selection_request>
  <request_identifier>ID_request_4</request_identifier>
  <template_data>
  <template_identifier>ID_resolution_document_template_1</template_
  identifier>
    <template_type>CUSTODY_AGREEMENT</template_type>
    <template_content>
      The following counter proposed custody agreement stipulates
ID_PLACEHOLDER_1 custody
      time split. ...
    </template_content>
  </template_data>
  <template_options_data>
    <template_option>
      <placeholder_identifier>ID_PLACEHOLDER_1</placeholder_
      identifier>
      <selection_option>
        <type>SELECT</type>
        <value>40% plaintiff / 60% defendant</value>
      </selection_option>
      <selection_option>
        <type>SELECT</type>
        <value>50% plaintiff / 50% defendant</value>
      </selection_option>
      <selection_option>
        <type>SELECT</type>
        <value>60% plaintiff / 40% defendant</value>
      </selection_option>
      <selection_option>
        <type>USER_FILL_IN</type>
      </selection_option>
    </template_option>
    ...
  </template_options_data>
</template_options_selection_request>
```

Attorney Docket No.: BattleTested0001US 38

The client 202 may send a template options selection response 249 to the CRAEML server 206 with the user's selection of values for resolution document template options. In one implementation, the template options selection response may include data such as a response identifier, selected resolution document template options values, and/or the like. In one embodiment, the client may provide the following example template options selection response, substantially in the form of a HTTP(S) POST message including XML-formatted data, as provided below:

```
POST /template_options_selection_response.php HTTP/1.1
Host: www.server.com
Content-Type: Application/XML
Content-Length: 667
<?XML version = ″1.0″ encoding = ″UTF-8″?>
<template_options_selection_response>
  <response_identifier>ID_response_4</response_identifier>
  <template_identifier>ID_resolution_document_template_1</template_
  identifier>
  <template_option_selection>
    <placeholder_identifier>ID_PLACEHOLDER_1</placeholder_
    identifier>
    <value>50% plaintiff / 50% defendant</value>
  </template_option_selection>
  ...
</template_options_selection_response>
```

The CRAEML server 206 may send a matter milestone interaction output 253 to the client 202 to provide the generated resolution document (e.g., to the user). In one implementation, the matter milestone interaction output may include data such as a response identifier, the generated resolution document, and/or the like. In one embodiment, the CRAEML server may provide the following example matter milestone interaction output, substantially in the form of a HTTP(S) POST message including XML-formatted data, as provided below:

```
POST /matter_milestone_interaction_output.php HTTP/1.1
Host: www.server.com
Content-Type: Application/XML
Content-Length: 667
<?XML version = ″1.0″ encoding = ″UTF-8″?>
<matter_milestone_interaction_output>
  <response_identifier>ID_response_1</response_identifier>
  <document_identifier>ID_resolution_document_1</document_identifier>
  <document_content>content (e.g., PDF file) of a counter proposed
custody agreement</document_content>
</matter_milestone_interaction_output>
```

FIG. 3 shows non-limiting, example embodiments of a logic flow illustrating a matter milestone interaction processing (MMIP) component for the CRAEML. In FIG. 3, a matter milestone interaction processing request may be obtained at 301. For example, the matter milestone interaction processing request may be obtained as a result of a request from a user to generate a resolution document in response to a milestone document. In one implementation, the matter milestone interaction processing request may be obtained via a user interface comprising web forms (e.g., via a website, via an app) utilized by the user to provide matter milestone interaction input data. In another implementation, the matter milestone interaction processing request may be obtained via a user interface comprising an AI chatbot (e.g., implemented via a large language model (LLM) such as OpenAI's ChatGPT, Google's Gemini, Meta's LLaMA, etc.) that collects matter milestone interaction input data from the user. In another implementation, the matter milestone interaction processing request may be obtained via a request to an API implemented by the CRAEML.

A milestone document associated with the matter milestone interaction processing request may be determined at 305. In one embodiment, a milestone document associated with a matter (e.g., a family court case (e.g., a divorce case involving a custody dispute), a licensing agreement (e.g., for an invention)) may be a document (e.g., a controversy document such as a proposed custody agreement, an offer document such as a licensing agreement offer) that corresponds to a change in the development of the matter that should be addressed with a resolution document (e.g., a response to the milestone document). For example, the milestone document associated with the matter milestone interaction processing request may be a (e.g., PDF) file comprising a custody agreement proposed by the opposing party. In one implementation, the matter milestone interaction processing request may be parsed (e.g., using PHP or Python commands) to determine data corresponding to the milestone document (e.g., based on the values of the document_identifier, document_type, document_content fields).

Milestone document details associated with the milestone document may be determined at 309. In one embodiment, the milestone document may be analyzed to tag, label, organize, extract, and/or the like structured and/or unstructured data specified via the milestone document. For example, milestone document details such as the source of the milestone document, a date associated with the milestone document, subject matter discussed in the milestone document, sentiment of the milestone document, document references, venue references, and/or the like may be determined. In one implementation, the milestone document may be analyzed via natural language processing to determine the milestone document details. For example, the custody agreement proposed by the opposing party may be analyzed to determine stipulated custody time split (e.g., 70% plaintiff/30% defendant).

A matter associated with the matter milestone interaction processing request may be determined at 313. For example, an identifier of the divorce case may be determined. In one implementation, the matter milestone interaction processing request may be parsed (e.g., using PHP commands) to determine the associated matter (e.g., based on the value of the case_identifier field).

Relevant matter data associated with the matter may be retrieved at 317. For example, relevant matter data may comprise previous motions, opposing counsel notices, court orders, expert reports, and/or the like associated with the matter that are relevant with respect to the milestone document. In one implementation, a machine learning component (e.g., a neural network) may be utilized to determine the relevant matter data. For example, the machine learning component may evaluate the milestone document details with respect to matter data associated with the matter to determine the relevant matter data (e.g., in a divorce case, the relevant matter data for a proposed custody agreement may comprise documents related to custody (e.g., previous court orders regarding custody time split)).

Prior matters similar to the matter may be determined at 321. For example, prior divorce cases in the state of filing that involved custody disputed may be determined. In various implementations, similar prior matters may be determined, by analyzing search query parameters, as one or more of: cases in the state of filing (e.g., divorce cases), cases across US family court, cases found using Shepardize via Lexis, cases found via an LLM search with legal training, cases retrieved from the CRAEML database (e.g., with a divorce case type), and/or the like. For example, the similar prior matters may be determined via a MySQL database command similar to the following:

SELECT *
FROM Cases
WHERE caseType = ′DIVORCE′ AND
associatedVenueID IN ′court associated with the matter, judge associated
with the matter′;

In some implementations, the relevant matter data may be utilized as part of the search query parameters to determine the similar prior matters.

Best matching resolution document templates for the milestone document may be determined at 325. In one embodiment, resolution document templates that have the highest likelihood of producing a successful outcome (e.g., a court order in favor of the user, the opposing party's acceptance of the user's counter proposal) for the user with regard to the milestone document may be determined. For example, the best matching resolution document templates for the milestone document may be determined as a template for a counter proposal custody agreement (e.g., having a 65% chance of success) and a template for a motion to the court that includes an expert report (e.g., having a 58% chance of success). In one implementation, a machine learning component (e.g., a neural network) may be utilized to determine the best matching resolution document templates for the milestone document. For example, the machine learning component may evaluate the milestone document details, the relevant matter data, the similar prior matters data (e.g., associated documents (e.g., motions, notices) and/or feedback (e.g., success or failure determined based on court orders)), and/or the like to determine the best matching resolution document templates for the milestone document. In some implementations, the machine learning component may calculate a chance of success for each of the resolution document templates to determine the best matching resolution document templates for the milestone document.

A determination may be made at 329 whether there remain resolution document templates to process. In one implementation, each of the best matching resolution document templates for the milestone document may be processed. If there remain best matching resolution document templates to process, the next best matching resolution document template may be selected for processing at 333.

Template placeholders associated with the selected resolution document template may be determined at 337. In one embodiment, a template placeholder may facilitate customization of a resolution document generated using a resolution document template by indicating content that should be adapted to address the particulars associated with the milestone document and/or with the user's matter. In one implementation, the template placeholders associated with the selected resolution document template may be determined by searching for placeholder indicators (e.g., a set of special characters) specified in the template's content. In another implementation, the template placeholders associated with the selected resolution document template may be retrieved from the CRAEML database. For example, the associated template placeholders may be determined via a MySQL database command similar to the following:

SELECT templatePlaceholders
FROM Templates
WHERE templateID = template identifier of the selected resolution
document template;

Relevant template placeholder value(s) may be generated for each of the template placeholders associated with the selected resolution document template at 341. In one embodiment, a set of template placeholder values (e.g., constructed to have the highest likelihood of producing a successful outcome for the user with regard to the milestone document) from which the user may select a desired option may be generated for each of the template placeholders using an AI component. In one implementation, a prompt may be provided to an LLM to instruct the LLM to generate a set of template placeholder values for each of the template placeholders. For example, the prompt may comprise the milestone document details, the relevant matter data, the similar prior matters data, the selected resolution document template's content, details regarding each of the template placeholders (e.g., regarding what kind of values are expected), instructions to generate a set of template placeholder values (e.g., the number of values to generate for each of the template placeholders), instructions to construct values that maximize the likelihood of producing a successful outcome for the user, instructions regarding sentiment to utilize when generating values, and/or the like. In some implementations, the AI component may calculate how each of the generated values affects the chance of success of the selected resolution document template.

A resolution document template selection may be obtained from the user at 345. In one embodiment, the user may be prompted via the user interface to select a resolution document template to utilize from the best matching resolution document templates for the milestone document. For example, the type of resolution document template and/or the calculated chance of success may be shown to the user for each of the best matching resolution document templates for the milestone document, and the user may select the desired resolution document template to utilize (e.g., via the web forms, via the AI chatbot). In one implementation, the resolution document template selection may be obtained via a template options selection request and/or a corresponding template options selection response. For example, the user may be prompted to choose between a template for a counter proposal custody agreement (e.g., having a 65% chance of success) and a template for a motion to the court that includes an expert report (e.g., having a 58% chance of success), and may select the template for a counter proposal custody agreement as the resolution document template to utilize.

Placeholder value selections for the resolution document template to utilize may be obtained from the user at 349. In one embodiment, the user may be prompted via the user interface to select a placeholder value to utilize for each of the template placeholders associated with the resolution document template to utilize. For example, the content and/or how a value affects the chance of success may be shown to the user for each of the placeholder values for each of the template placeholders, and the user may select the desired value to utilize for each of the template placeholders (e.g., via the web forms, via the AI chatbot) and/or may customize a selected value and/or may fill in an alternative value. In one implementation, the placeholder value selections may be obtained via a template options selection request and/or a corresponding template options selection response. For example, the user may be prompted to choose between different custody time splits for a counter proposal custody agreement, and may select a value of 50% petitioner/plaintiff/50% respondent/defendant custody time split.

A resolution document may be composited in accordance with the user's selections at 353. In one embodiment, the content of the resolution document template to utilize and/or the placeholder value selections may be composited to generate the resolution document (e.g., a counter proposal custody agreement). In one implementation, template placeholders of the resolution document template to utilize may be replaced with corresponding placeholder value selections (e.g., using PHP commands) to composite the resolution document.

Available venue options for the resolution document may be determined at 357. For example, venue options data such as courts where the resolution document may be filed (e.g., county court, federal court, alternative dispute resolution mediator), judges associated with each court where the resolution document may be filed, opposing counsel, and/or the like may be determined. In one implementation, the available venue options for the resolution document may be determined via the CRAEML database. For example, the available venue options for the resolution document may be determined via a MySQL database command similar to the following:

```
SELECT *
FROM Venues
WHERE venueID IN
  (SELECT associatedVenueIDs
  FROM Cases
  WHERE caseID = ID_case_1);
```

A success likelihood for the resolution document may be determined for each available venue option at 361. In one implementation, a machine learning component (e.g., a neural network) may be utilized to determine a success likelihood for the resolution document for each available venue option. For example, the machine learning component may evaluate venue data such as previous decisions (e.g., issued by a court, issued by a judge), backgrounds (e.g., of judges, of opposing counsel), rules (e.g., local rules for a court), and/or the like associated with a venue option to calculate a chance of success for the resolution document for each available venue option.

A venue selection may be obtained from the user at 365. In one embodiment, the user may be prompted via the user interface to select a venue to utilize from the available venue options for the resolution document. For example, the name and/or the calculated chance of success may be shown to the user for each of the available venue options for the resolution document, and the user may select the desired venue to utilize (e.g., via the web forms, via the AI chatbot). In one implementation, the venue selection may be obtained via a template options selection request and/or a corresponding template options selection response. For example, the user may be prompted to choose between filing the resolution document with an alternative dispute resolution mediator or with a county court, and may select to file with the county court.

Best matching resolution document templates for the selected venue may be determined at 369. In one embodiment, resolution document templates that have the highest likelihood of producing a successful outcome for the user with regard to the milestone document in the selected venue may be determined. For example, the best matching resolution document templates for the milestone document in the selected venue may be determined as a template for a counter proposal custody agreement (e.g., having a 63% chance of success in the selected venue) and a template for a motion to the court that includes an expert report (e.g., having a 68% chance of success in the selected venue). In one implementation, a machine learning component (e.g., a neural network) may be utilized to determine the best matching resolution document templates for the milestone document in the selected venue. For example, the machine learning component may evaluate the milestone document details, the relevant matter data, the similar prior matters data (e.g., associated documents (e.g., motions, notices) and/or feedback (e.g., success or failure determined based on court orders)), venue data associated with the selected venue, and/or the like to determine the best matching resolution document templates for the milestone document in the selected venue. In some implementations, the machine learning component may calculate a chance of success for each of the resolution document templates to determine the best matching resolution document templates for the milestone document in the selected venue.

A determination may be made at 373 whether higher success likelihood template(s) exist for the milestone document in the selected venue. For example, it may be determined that while typically a template for a counter proposal custody agreement has a 65% chance of success and a template for a motion to the court that includes an expert report has a 58% chance of success, in the selected venue a template for a counter proposal custody agreement (e.g., currently selected by the user) has a 63% chance of success and a template for a motion to the court that includes an expert report has a 68% chance of success, indicating that a higher success likelihood template exists for the milestone document in the selected venue.

If higher success likelihood template(s) exist for the milestone document in the selected venue, the user may be notified regarding the higher success likelihood resolution document templates for the milestone document in the selected venue and/or may be prompted whether an alternative template selection is desired via the user interface (e.g., “A template with a higher success likelihood exists for this venue. Would you like to use it instead of the current template?”) at 377. A determination may be made at 381 whether an alternative template selection is indicated by the user. If the user selects an alternative resolution document template (e.g., with a higher success likelihood for the milestone document in the selected venue) to utilize, the alternative resolution document template may be processed as discussed starting at 329. In some implementations, template placeholder values for the template placeholders associated with the alternative resolution document template may be generated using venue data associated with the selected venue (e.g., constructed to have the highest likelihood of producing a successful outcome for the user with regard to the milestone document in the selected venue).

The generated resolution document may be provided at 385. For example, the generated resolution document may be provided to the user as a (e.g., PDF) file (e.g., via the user interface, via the API). In another example, the generated resolution document may be filed with the selected venue (e.g., via a state court website). In one implementation, the generated resolution document may be provided via a matter milestone interaction output.

Feedback for the generated resolution document may be processed at 389. In one embodiment, the feedback for the generated resolution document may indicate whether the generated resolution document produced a successful outcome (e.g., success or failure determined based on a court order). In one implementation, the feedback for the generated resolution document may be obtained from a venue (e.g., via a state court website). In another implementation, the feedback for the generated resolution document may be obtained as a milestone document via another matter milestone interaction processing request. In one embodiment, the feedback for the generated resolution document may be incorporated to improve performance of the AI component and/or of the ML component. In one implementation, the feedback for the generated resolution document may be added to the matter corpus of the CRAEML and/or may be provided as training data to the LLM to improve performance of the LLM and/or as training data to the neural network to improve performance of the neural network.

A determination may be made at 393 whether to continue with a next matter milestone. If so, the next matter milestone may be processed as discussed starting at 301.

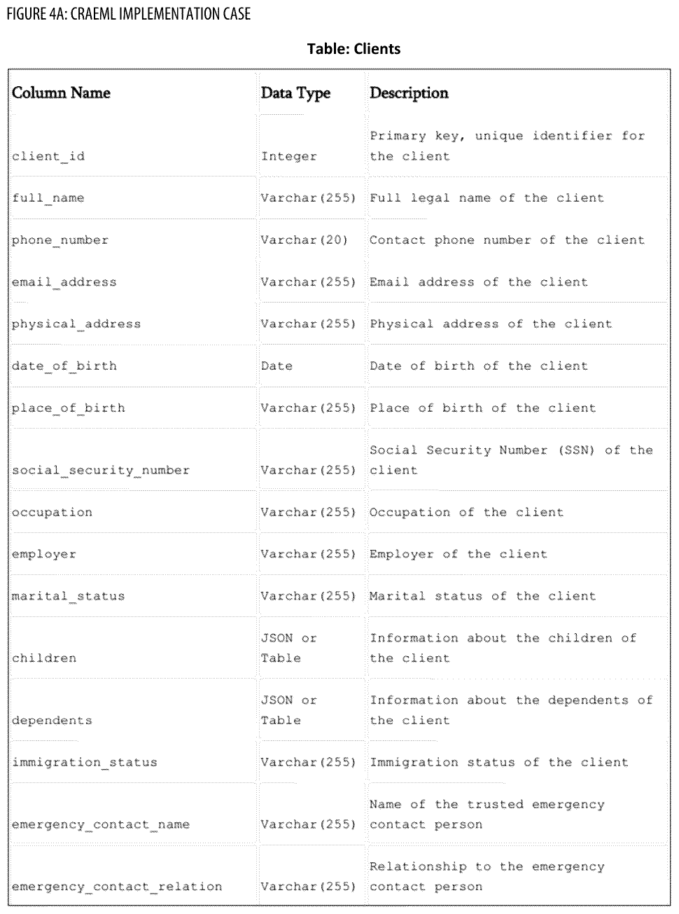

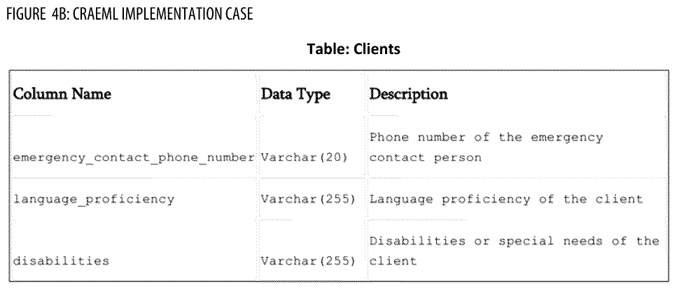

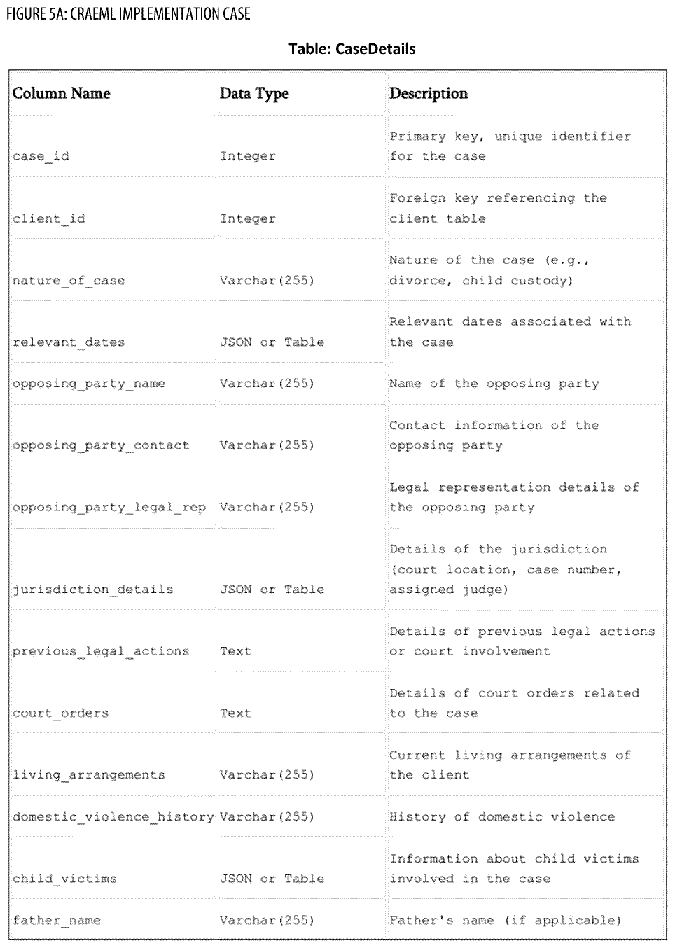

FIGS. 4A-B show non-limiting, example embodiments of implementation case(s) for the CRAEML. In FIGS. 4A-B, an exemplary database schema for a Clients table that stores information regarding users is illustrated.

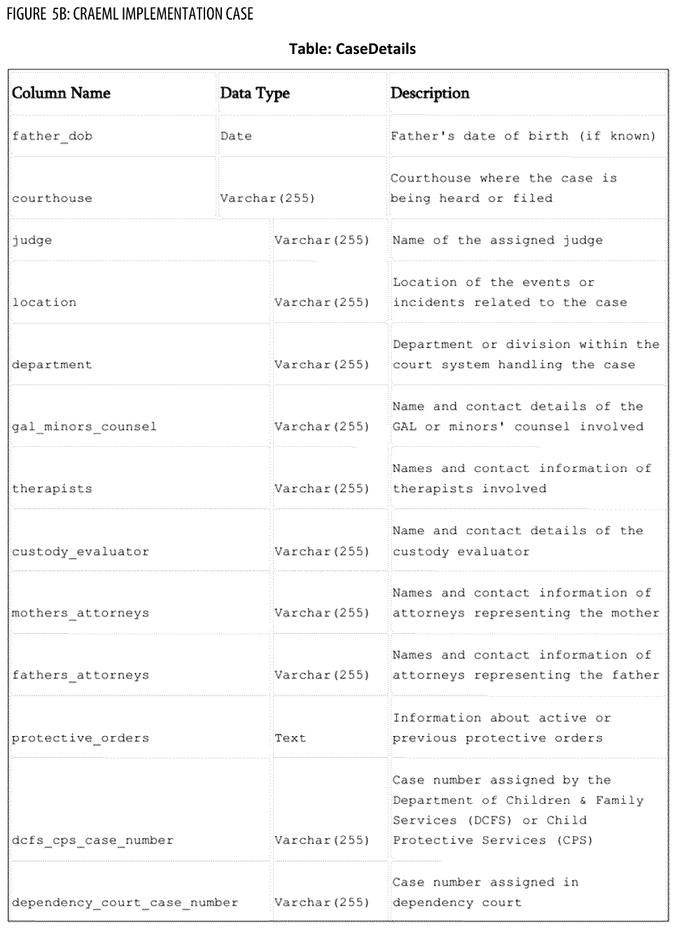

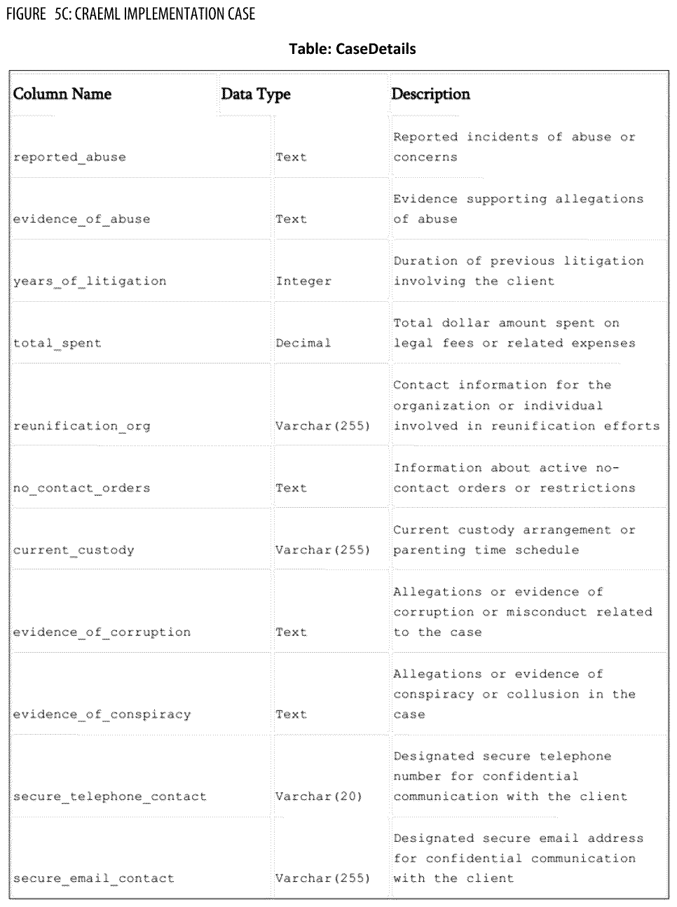

FIGS. 5A-C show non-limiting, example embodiments of implementation case(s) for the CRAEML. In FIGS. 5A-C, an exemplary database schema for a CaseDetails table that stores information regarding matters (e.g., legal cases) is illustrated.

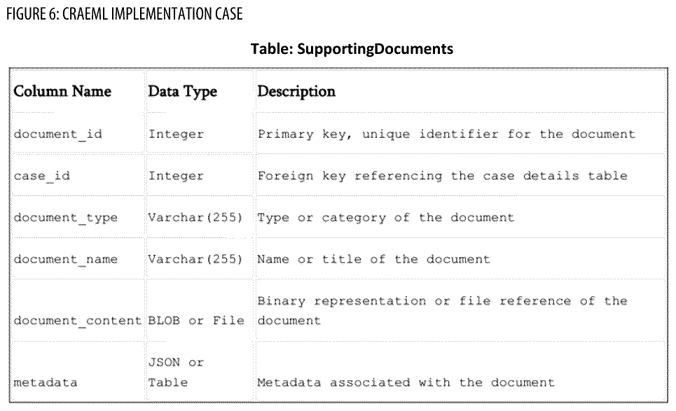

FIG. 6 shows non-limiting, example embodiments of implementation case(s) for the CRAEML. In FIG. 6, an exemplary database schema for a SupportingDocuments table that stores information regarding documents associated with matters is illustrated.

### Additional Alternative Embodiment Examples

The following alternative example embodiments provide a number of variations of some of the already discussed principles for expanded color on the abilities of the CRAEML.

Additional embodiments may include:
1. A resolution document generating apparatus, comprising: at least one memory;
a component collection stored in the at least one memory;
any of at least one processor disposed in communication with the at least one memory, the any of
at least one processor executing processor-executable instructions from the component collection, the component collection storage structured with processor-executable instructions comprising:
   obtain, via any of at least one processor, a matter milestone interaction request datastructure, in which the matter milestone interaction request datastructure is structured as specifying a milestone document associated with a matter;
   determine, via any of at least one processor, milestone document details associated with the milestone document via a natural language processing engine;
   evaluate, via any of at least one processor, via a first machine learning prediction logic datastructure, the milestone document details with respect to matter data associated with the matter to determine relevant matter data;
   determine, via any of at least one processor, a set of similar prior matters that are similar to the matter by executing a search query;
   evaluate, via any of at least one processor, via a second machine learning prediction logic datastructure, the milestone document details, the relevant matter data and similar prior matters data associated with the set of similar prior matters with respect to resolution document templates to determine a first best matching resolution document template for the milestone document;
   provide, via any of at least one processor, a prompt to a large language model to instruct the large language model to generate a set of template placeholder values for a template placeholder of the first best matching resolution document template;
   obtain, via any of at least one processor, user selection of a template placeholder value to utilize from the set of template placeholder values; and
   composite, via any of at least one processor, content of the first best matching resolution document template and the selected template placeholder value to utilize to generate a resolution document.
2. The apparatus of embodiment 1, in which the matter milestone interaction request datastructure is generated via a large language model chatbot.
3. The apparatus of embodiment 1, in which the milestone document details comprise at least one of: a source of the milestone document, a date associated with the milestone document, subject matter discussed in the milestone document, sentiment of the milestone document, a document reference, a venue reference.
4. The apparatus of embodiment 1, in which the first machine learning prediction logic datastructure and the second machine learning prediction logic datastructure are implemented via any of: Bayesian network, classification prediction logic datastructure, decision tree, neural network, regression prediction logic datastructure.
5. The apparatus of embodiment 1, in which the search query specifies a matter type of the matter as a search query parameter.
6. The apparatus of embodiment 1, in which the search query specifies a venue associated with the matter as a search query parameter.
7. The apparatus of embodiment 1, in which the search query specifies at least some of the relevant matter data as a search query parameter.
8. The apparatus of embodiment 1, in which the search query is executed via a large language model search.
9. The apparatus of embodiment 1, in which the first best matching resolution document template is calculated to have a high likelihood of producing a successful outcome with regard to the milestone document.
10. The apparatus of embodiment 1, in which the prompt is structured to comprise instructions to construct template placeholder values that maximize likelihood of producing a successful outcome with regard to the milestone document.
11. The apparatus of embodiment 1, in which the user selection of the template placeholder value to utilize is obtained via a large language model chatbot.
12. The apparatus of embodiment 1, in which the component collection storage is further structured with processor-executable instructions comprising:
provide, via any of at least one processor, the generated resolution document.
13. The apparatus of embodiment 12, in which the instructions to provide the generated resolution document are structured as instructions to file the generated resolution document with a venue.
14. The apparatus of embodiment 12, in which the component collection storage is further structured with processor-executable instructions comprising:
obtain, via any of at least one processor, feedback with regard to the provided resolution document; and
datastructure via training data comprising the feedback.
15. The apparatus of embodiment 1, in which the component collection storage is further structured with processor-executable instructions comprising:
obtain, via any of at least one processor, user selection of a venue to utilize for the resolution document;
calculate, via any of at least one processor, a first likelihood of producing a successful outcome with regard to the milestone document in the selected venue for the resolution document;
determine, via any of at least one processor, that a second best matching resolution document template exists for the milestone document in the selected venue, in which the second best matching resolution document template has a calculated second likelihood of producing a successful outcome with regard to the milestone
document in the selected venue that is higher than the calculated first likelihood; and
generate, via any of at least one processor, an alternative resolution document via the second best matching resolution document template.
16. A resolution document generating processor-readable, non-transient medium, the medium storing a component collection, the component collection storage structured with processor-executable instructions comprising:
obtain, via any of at least one processor, a matter milestone interaction request datastructure, in which the matter milestone interaction request datastructure is structured as specifying a milestone document associated with a matter;
determine, via any of at least one processor, milestone document details associated with the milestone document via a natural language processing engine;
evaluate, via any of at least one processor, via a first machine learning prediction logic datastructure, the milestone document details with respect to matter data associated with the matter to determine relevant matter data;
determine, via any of at least one processor, a set of similar prior matters that are similar to the matter by executing a search query;
datastructure, the milestone document details, the relevant matter data and similar prior matters data associated with the set of similar prior matters with respect to resolution document templates to determine a first best matching resolution document template for the milestone document;
provide, via any of at least one processor, a prompt to a large language model to instruct the large language model to generate a set of template placeholder values for a template placeholder of the first best matching resolution document template;
obtain, via any of at least one processor, user selection of a template placeholder value to utilize from the set of template placeholder values; and
composite, via any of at least one processor, content of the first best matching resolution document template and the selected template placeholder value to utilize to generate a resolution document.
17. The medium of embodiment 16, in which the matter milestone interaction request datastructure is generated via a large language model chatbot.
18. The medium of embodiment 16, in which the milestone document details comprise at least one of: a source of the milestone document, a date associated with the milestone document, subject matter discussed in the milestone document, sentiment of the milestone document, a document reference, a venue reference.
19. The medium of embodiment 16, in which the first machine learning prediction logic datastructure and the second machine learning prediction logic datastructure are implemented via any of: Bayesian network, classification prediction logic datastructure, decision tree, neural network, regression prediction logic datastructure.
20. The medium of embodiment 16, in which the search query specifies a matter type of the matter as a search query parameter.
21. The medium of embodiment 16, in which the search query specifies a venue associated with the matter as a search query parameter.
22. The medium of embodiment 16, in which the search query specifies at least some of the relevant matter data as a search query parameter.
23. The medium of embodiment 16, in which the search query is executed via a large language
24. The medium of embodiment 16, in which the first best matching resolution document template is calculated to have a high likelihood of producing a successful outcome with regard to the milestone document.
25. The medium of embodiment 16, in which the prompt is structured to comprise instructions to construct template placeholder values that maximize likelihood of producing a successful outcome with regard to the milestone document.
26. The medium of embodiment 16, in which the user selection of the template placeholder value to utilize is obtained via a large language model chatbot.
27. The medium of embodiment 16, in which the component collection storage is further structured with processor-executable instructions comprising:
provide, via any of at least one processor, the generated resolution document.
28. The medium of embodiment 27, in which the instructions to provide the generated resolution document are structured as instructions to file the generated resolution document with a venue.
29. The medium of embodiment 27, in which the component collection storage is further structured with processor-executable instructions comprising:
obtain, via any of at least one processor, feedback with regard to the provided resolution document; and
update, via any of at least one processor, the second machine learning prediction logic datastructure via training data comprising the feedback.
30. The medium of embodiment 16, in which the component collection storage is further structured with processor-executable instructions comprising:
obtain, via any of at least one processor, user selection of a venue to utilize for the resolution document;
calculate, via any of at least one processor, a first likelihood of producing a successful outcome with regard to the milestone document in the selected venue for the resolution document;
determine, via any of at least one processor, that a second best matching resolution document template exists for the milestone document in the selected venue, in which the second best matching resolution document template has a calculated second likelihood of producing a successful outcome with regard to the milestone document in the selected venue that is higher than the calculated first likelihood; and
generate, via any of at least one processor, an alternative resolution document via the second best matching resolution document template.
31. A resolution document generating processor-implemented system, comprising:
means to store a component collection;
means to process processor-executable instructions from the component collection, the component collection storage structured with processor-executable instructions comprising:
   obtain, via any of at least one processor, a matter milestone interaction request datastructure, in which the matter milestone interaction request datastructure is structured as specifying a milestone document associated with a matter;
   determine, via any of at least one processor, milestone document details associated with the milestone document via a natural language processing engine;
   evaluate, via any of at least one processor, via a first machine learning prediction logic datastructure, the milestone document details with respect to matter data associated with the matter to determine relevant matter data;
   determine, via any of at least one processor, a set of similar prior matters that are similar to the matter by executing a search query;
   evaluate, via any of at least one processor, via a second machine learning prediction logic datastructure, the milestone document details, the relevant matter data and similar prior matters data associated with the set of similar prior matters with respect to resolution document templates to determine a first best matching resolution document template for the milestone document;
   provide, via any of at least one processor, a prompt to a large language model to instruct the large language model to generate a set of template placeholder values for a template placeholder of the first best matching resolution document template;
   obtain, via any of at least one processor, user selection of a template placeholder value to utilize from the set of template placeholder values; and
   composite, via any of at least one processor, content of the first best matching resolution document template and the selected template placeholder value to utilize to generate a resolution document.
32. The system of embodiment 31, in which the matter milestone interaction request datastructure is generated via a large language model chatbot.
33. The system of embodiment 31, in which the milestone document details comprise at least one of: a source of the milestone document, a date associated with the milestone document, subject matter discussed in the milestone document, sentiment of the milestone document, a document reference, a venue reference.
34. The system of embodiment 31, in which the first machine learning prediction logic datastructure and the second machine learning prediction logic datastructure are implemented via any of: Bayesian network, classification prediction logic datastructure, decision tree, neural network, regression prediction logic datastructure.
35. The system of embodiment 31, in which the search query specifies a matter type of the matter as a search query parameter.
36. The system of embodiment 31, in which the search query specifies a venue associated with the matter as a search query parameter.
37. The system of embodiment 31, in which the search query specifies at least some of the relevant matter data as a search query parameter.
38. The system of embodiment 31, in which the search query is executed via a large language model search.
39. The system of embodiment 31, in which the first best matching resolution document template is calculated to have a high likelihood of producing a successful outcome with regard to the milestone document.
40. The system of embodiment 31, in which the prompt is structured to comprise instructions to construct template placeholder values that maximize likelihood of producing a successful outcome with regard to the milestone document.
41. The system of embodiment 31, in which the user selection of the template placeholder value to utilize is obtained via a large language model chatbot.
42. The system of embodiment 31, in which the component collection storage is further structured with processor-executable instructions comprising:
provide, via any of at least one processor, the generated resolution document.
43. The system of embodiment 42, in which the instructions to provide the generated resolution document are structured as instructions to file the generated resolution document with a venue.
44. The system of embodiment 42, in which the component collection storage is further structured with processor-executable instructions comprising:
obtain, via any of at least one processor, feedback with regard to the provided resolution document; and
update, via any of at least one processor, the second machine learning prediction logic datastructure via training data comprising the feedback.
45. The system of embodiment 31, in which the component collection storage is further structured with processor-executable instructions comprising:
obtain, via any of at least one processor, user selection of a venue to utilize for the resolution document;
calculate, via any of at least one processor, a first likelihood of producing a successful outcome with regard to the milestone document in the selected venue for the resolution document;
determine, via any of at least one processor, that a second best matching resolution document template exists for the milestone document in the selected venue, in which the second best matching resolution document template has a calculated second likelihood of producing a successful outcome with regard to the milestone document in the selected venue that is higher than the calculated first likelihood; and
generate, via any of at least one processor, an alternative resolution document via the second best matching resolution document template.
46. A resolution document generating processor-implemented process, including processing processor-executable instructions via any of at least one processor from a component collection stored in at least one memory, the component collection storage structured with processor-executable instructions comprising:
obtain, via any of at least one processor, a matter milestone interaction request datastructure, in which the matter milestone interaction request datastructure is structured as specifying a milestone document associated with a matter;
determine, via any of at least one processor, milestone document details associated with the milestone document via a natural language processing engine;
evaluate, via any of at least one processor, via a first machine learning prediction logic datastructure, the milestone document details with respect to matter data associated with the matter to determine relevant matter data;
determine, via any of at least one processor, a set of similar prior matters that are similar to the matter by executing a search query;
evaluate, via any of at least one processor, via a secong machine learning prediction logic datastructure, the milestone document details, the relevant matter data and similar prior matters data associated with the set of similar prior matters with respect to resolution document templates to determine a first best matching resolution document template for the milestone document;
provide, via any of at least one processor, a prompt to a large language model to instruct the large language model to generate a set of template placeholder values for a template placeholder of the first best matching resolution document template;
obtain, via any of at least one processor, user selection of a template placeholder value to utilize from the set of template placeholder values; and
composite, via any of at least one processor, content of the first best matching resolution document template and the selected template placeholder value to utilize to generate a resolution document.
47. The process of embodiment 46, in which the matter milestone interaction request datastructure is generated via a large language model chatbot.
48. The process of embodiment 46, in which the milestone document details comprise at least one of: a source of the milestone document, a date associated with the milestone document, subject matter discussed in the milestone document, sentiment of the milestone document, a document reference, a venue reference.
49. The process of embodiment 46, in which the first machine learning prediction logic datastructure and the second machine learning prediction logic datastructure are implemented via any of: Bayesian network, classification prediction logic datastructure, decision tree, neural network, regression prediction logic datastructure.
50. The process of embodiment 46, in which the search query specifies a matter type of the matter as a search query parameter.
51. The process of embodiment 46, in which the search query specifies a venue associated with the matter as a search query parameter.
52. The process of embodiment 46, in which the search query specifies at least some of the relevant matter data as a search query parameter.
53. The process of embodiment 46, in which the search query is executed via a large language
54. The process of embodiment 46, in which the first best matching resolution document template is calculated to have a high likelihood of producing a successful outcome with regard to the milestone document.
55. The process of embodiment 46, in which the prompt is structured to comprise instructions to construct template placeholder values that maximize likelihood of producing a successful outcome with regard to the milestone document.
56. The process of embodiment 46, in which the user selection of the template placeholder value to utilize is obtained via a large language model chatbot.
57. The process of embodiment 46, in which the component collection storage is further structured with processor-executable instructions comprising:
provide, via any of at least one processor, the generated resolution document.
58. The process of embodiment 57, in which the instructions to provide the generated resolution document are structured as instructions to file the generated resolution document with a venue.
59. The process of embodiment 57, in which the component collection storage is further structured with processor-executable instructions comprising:
obtain, via any of at least one processor, feedback with regard to the provided resolution document; and
update, via any of at least one processor, the second machine learning prediction logic datastructure via training data comprising the feedback.
60. The process of embodiment 46, in which the component collection storage is further structured with processor-executable instructions comprising:
obtain, via any of at least one processor, user selection of a venue to utilize for the resolution document;
calculate, via any of at least one processor, a first likelihood of producing a successful outcome with regard to the milestone document in the selected venue for the resolution document;
determine, via any of at least one processor, that a second best matching resolution document template exists for the milestone document in the selected venue, in which the second best matching resolution document template has a calculated second likelihood of producing a successful outcome with regard to the milestone document in the selected venue that is higher than the calculated first likelihood; and
generate, via any of at least one processor, an alternative resolution document via the second best matching resolution document template.
101. A controversy resolution document engine apparatus, comprising:
at least one memory;
a component collection stored in the at least one memory;
at least one processor disposed in communication with the at least one memory, the at least one processor executing processor-executable instructions from the component collection, the component collection storage structured with processor-executable instructions comprising:
   obtain, via the at least one processor, outcome resultant legal training documents;
   determine intermediate morph template machine learning engine datastructure via machine learning training engine by processing the outcome resulting legal training documents;
   obtain new controversy situation datastructure;
   determine requisite resolution documentation templates via intermediate morph template machine learning engine datastructure;
   determine dispute resolution form entry datastructure with the obtained new controversy situation datastructure for the requisite resolution documentation templates;
   populate the requisite resolution documentation templates with the determined dispute resolution form entry datastructure;
   provide the populated requisite resolution documentation templates.
102. The apparatus of embodiment 101, in which the provide the populated requisite resolution documentation templates are provided to an online dispute resolution entity.
103. A controversy resolution document engine processor-readable, non-transient medium, the medium storing a component collection, the component collection storage structured with processor-executable instructions comprising:
obtain, via the at least one processor, outcome resultant legal training documents;
determine intermediate morph template machine learning engine datastructure via machine learning training engine by processing the outcome resulting legal training documents;
obtain new controversy situation datastructure;
determine requisite resolution documentation templates via intermediate morph template machine learning engine datastructure;
determine dispute resolution form entry datastructure with the obtained new controversy situation datastructure for the requisite resolution documentation templates;
populate the requisite resolution documentation templates with the determined dispute resolution form entry datastructure;
provide the populated requisite resolution documentation templates.
104. The medium of embodiment 103, in which the provide the populated requisite resolution documentation templates are provided to an online dispute resolution entity.
105. A controversy resolution document engine processor-implemented system, comprising:
means to store a component collection;
means to process processor-executable instructions from the component collection, the component collection storage structured with processor-executable instructions including:
   obtain, via the at least one processor, outcome resultant legal training documents;
   determine intermediate morph template machine learning engine datastructure via machine learning training engine by processing the outcome resulting legal training documents;
   obtain new controversy situation datastructure;
   determine requisite resolution documentation templates via intermediate morph template machine learning engine datastructure;
   determine dispute resolution form entry datastructure with the obtained new controversy situation datastructure for the requisite resolution documentation templates;
   populate the requisite resolution documentation templates with the determined dispute resolution form entry datastructure;
   provide the populated requisite resolution documentation templates.
106. The system of embodiment 105, in which the provide the populated requisite resolution documentation templates are provided to an online dispute resolution entity.
107. A controversy resolution document engine process, including processing processor-executable instructions via at least one processor from a component collection stored in at least one memory, the component collection storage structured with processor-executable instructions comprising:
obtain, via the at least one processor, outcome resultant legal training documents;
determine intermediate morph template machine learning engine datastructure via machine learning training engine by processing the outcome resulting legal training documents;
obtain new controversy situation datastructure;
determine requisite resolution documentation templates via intermediate morph template machine learning engine datastructure;
determine dispute resolution form entry datastructure with the obtained new controversy situation datastructure for the requisite resolution documentation templates;
populate the requisite resolution documentation templates with the determined dispute resolution form entry datastructure;
provide the populated requisite resolution documentation templates.
108. The process of embodiment 107, in which the provide the populated requisite resolution documentation templates are provided to an online dispute resolution entity.

### CRAEML CONTROLLER

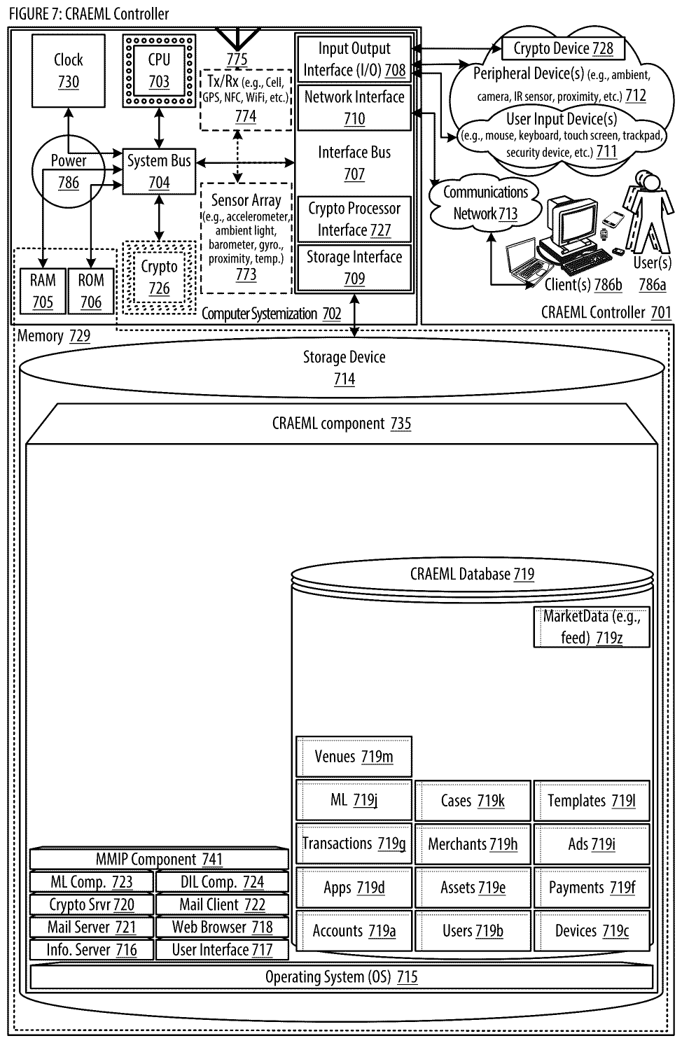

FIG. 7 shows a block diagram illustrating non-limiting, example embodiments of a CRAEML controller. In this embodiment, the CRAEML controller 701 may serve to aggregate, process, store, search, serve, identify, instruct, generate, match, and/or facilitate interactions with a computer through machine learning technologies, and/or other related data.

Users, which may be people and/or other systems, may engage information technology systems (e.g., computers) to facilitate information processing. In turn, computers employ processors to process information; such processors 703 may be referred to as central processing units (CPU). One form of processor is referred to as a microprocessor. CPUs use communicative circuits to pass binary encoded signals acting as instructions to allow various operations. These instructions may be operational and/or data instructions containing and/or referencing other instructions and data in various processor accessible and operable areas of memory 729 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the CRAEML controller 701 may be connected to and/or communicate with entities such as, but not limited to any of: one or more users from peripheral devices 712 (e.g., user input devices 711); an optional cryptographic processor device 728; and/or a communications network 713.

Networks comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is referred to as a “node.” Networks are generally thought to facilitate the transfer of information from source points to destinations. A node specifically tasked with furthering the passage of information from a source to a destination is called a “router.” There are many forms of networks such as Local Area Networks (LANs), Pico networks, Wide Area Networks (WANs), Wireless Networks (WLANs), etc. For example, the Internet is, generally, an interconnection of a multitude of networks whereby remote clients and servers may access and interoperate with one another.

The CRAEML controller 701 may be based on computer systems that may comprise, but are not limited to, components such as any of: a computer systemization 702 connected to memory 729.

### Computer Systemization

A computer systemization 702 may comprise a clock 730, central processing unit (“CPU(s)” and/or “processor(s)” (these terms are used interchangeably throughout the disclosure unless noted to the contrary)) 703, a memory 729 (e.g., a read only memory (ROM) 706, a random access memory (RAM) 705, etc.), and/or an interface bus 707, and most frequently, although not necessarily, are all interconnected and/or communicating through a system bus 704 on one or more (mother) board(s) 702 having conductive and/or otherwise transportive circuit pathways through which instructions (e.g., binary encoded signals) may travel to effectuate communications, operations, storage, etc. The computer systemization may be connected to a power source 786; e.g., optionally the power source may be internal. Optionally, a cryptographic processor 726 may be connected to the system bus. In another embodiment, the cryptographic processor, transceivers (e.g., ICs) 774, and/or sensor array (e.g., any of: accelerometer, altimeter, ambient light, barometer, global positioning system (GPS) (thereby allowing CRAEML controller to determine its location), gyroscope, magnetometer, pedometer, proximity, ultra-violet sensor, etc.) 773 may be connected as either internal and/or external peripheral devices 712 via the interface bus I/O 708 (not pictured) and/or directly via the interface bus 707. In turn, the transceivers may be connected to antenna(s) 775, thereby effectuating wireless transmission and reception of various communication and/or sensor protocols; for example the antenna(s) may connect to various transceiver chipsets (depending on deployment needs), including any of: Broadcom® BCM4329FKUBG transceiver chip (e.g., providing 802.11n, Bluetooth® 2.1+EDR, FM, etc.); a Broadcom® BCM4752 GPS receiver with accelerometer, altimeter, GPS, gyroscope, magnetometer; a Broadcom® BCM4335transceiver chip (e.g., providing 2G, 3G, and 4G long-term evolution (LTE) cellular communications; 802.11ac, Bluetooth® 4.0 low energy (LE) (e.g., beacon features)); a Broadcom® BCM43341 transceiver chip (e.g., providing 2G, 3G and 4G LTE cellular communications; 802.11g, Bluetooth® 4.0, near field communication (NFC), FM radio); an Infineon Technologies® X-Gold 618-PMB9800 transceiver chip (e.g., providing 2G/3G HSDPA/HSUPA communications); a MediaTek® MT6620 transceiver chip (e.g., providing 802.11n (also known as WiFi® in numerous iterations), Bluetooth® 4.0 LE, FM, GPS; a Lapis Semiconductor® ML8511 UV sensor; a Maxim Integrated® MAX44000 ambient light and infrared proximity sensor; a Texas Instruments® WiLink® WL1283 transceiver chip (e.g., providing 802.11n, Bluetooth® 3.0, FM, GPS); and/or the like. The system clock may have a crystal oscillator and generates a base signal through the computer systemization's circuit pathways. The clock may be coupled to the system bus and various clock multipliers that may increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to any of: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU is often packaged in a number of formats varying from large supercomputer(s) and mainframe(s) computers, down to mini computers, servers, desktop computers, laptops, thin clients (e.g., Chromebooks®), netbooks, tablets (e.g., Android®, iPads®, and Windows® tablets, etc.), mobile smartphones (e.g., Android®, iPhones®, Nokia®, Palm® and Windows® phones, etc.), wearable device(s) (e.g., headsets (e.g., Apple AirPods (Pro)®, glasses, goggles (e.g., Apple Vision Pro®, Google Glass®), watches, etc.), and/or the like. Often, the processors themselves may incorporate various specialized processing units, such as, but not limited to any of: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 729 beyond the processor itself; internal memory may include, but is not limited to any of: fast registers, various levels of cache memory (e.g., level 1, 2, 3, etc.), (dynamic/static) RAM, solid state memory, etc. The processor may access this memory through the use of a memory address space that is accessible via instruction address, which the processor can construct and decode allowing it to access a circuit path to a specific memory address space having a memory state. The CPU may be a microprocessor such as: AMD's® Athlon®, Duron® and/or Opteron®; Apple's® A, M, S, U series of processors (e.g., A5, A6, A7, A8. . . . M1, M2. . . . S1,S2. . . . U1 . . . etc.); ARM's® application, embedded and secure processors; IBM® and/or Motorola's DragonBall® and PowerPC®; IBM's® and Sony's® Cell processor; Intel's® 80X86 series (e.g., 80386, 80486), Pentium®, Celeron®, Core (2) Duo®, i series (e.g., i3, i5, i7, 19, etc.), Itanium®, Xeon®, and/or XScale®; Motorola's® 680X0 series (e.g., 68020, 68030, 68040, etc.); and/or the like processor(s). The CPU interacts with memory through instruction passing through conductive and/or transportive conduits (e.g., (printed) electronic and/or optic circuits) to execute stored instructions (i.e., program code), e.g., via load/read address commands; e.g., the CPU may read processor issuable instructions from memory (e.g., reading it from a component collection (e.g., an interpreted and/or compiled program application/library including allowing the processor to execute instructions from the application/library) stored in the memory). Such instruction passing facilitates communication within the CRAEML controller and beyond through various interfaces. Should processing requirements dictate a greater amount speed and/or capacity, distributed processors (e.g., see Distributed CRAEML below), mainframe, multi-core, parallel, and/or super-computer architectures may similarly be employed. Alternatively, should deployment requirements dictate greater portability, smaller mobile devices (e.g., Personal Digital Assistants (PDAs)) may be employed.

Depending on the particular implementation, features of the CRAEML may be achieved by implementing a microcontroller such as any of: CAST's® R8051XC2 microcontroller; Diligent's® Basys 3 Artix-7, Nexys A7-100T, U192015125IT, etc.; Intel's® MCS 51 (i.e., 8051microcontroller); and/or the like. Also, to implement certain features of the CRAEML, some feature implementations may rely on embedded components, such as any of: Application-Specific Integrated Circuit (“ASIC”), Digital Signal Processing (“DSP”), Field Programmable Gate Array (“FPGA”), and/or the like embedded technology. For example, any of the CRAEML component collection (distributed or otherwise) and/or features may be implemented via the microprocessor and/or via embedded components; e.g., via any of: ASIC, coprocessor, DSP, FPGA, and/or the like. Alternately, some implementations of the CRAEML may be implemented with embedded components that are configured and used to achieve a variety of features or signal processing.

Depending on the particular implementation, the embedded components may include software solutions, hardware solutions, and/or some combination of both hardware/software solutions. For example, CRAEML features discussed herein may be achieved through implementing FPGAs, which are a semiconductor devices containing programmable logic components called “logic blocks”, and programmable interconnects, such as any of: the high performance FPGA Virtex® series, the low cost Spartan® series manufactured by Xilinx®, and/or the like. Logic blocks and interconnects can be programmed by the customer or designer, after the FPGA is manufactured, to implement any of the CRAEML features. A hierarchy of programmable interconnects allow logic blocks to be interconnected as needed by the CRAEML system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the CRAEML may be developed on FPGAS and then migrated into a fixed version that more resembles ASIC implementations. Alternate or coordinating implementations may migrate CRAEML controller features to a final ASIC instead of or in addition to FPGAs. Depending on the implementation all of the aforementioned embedded components and microprocessors may be considered the “CPU” and/or “processor” for the CRAEML.

### Power Source

The power source 786 may be of any various form for powering small electronic circuit board devices such as any of the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 786 is connected to at least one of the interconnected subsequent components of the CRAEML thereby providing an electric current to all subsequent components. In one example, the power source 786 is connected to the system bus component 704. In an alternative embodiment, an outside power source 786 is provided through a connection across the I/O 708 interface. For example, Ethernet (with power on Ethernet), IEEE 1394, USB and/or the like connections carry both data and power across the connection and is therefore a suitable source of power.

### Interface Adapters

Interface bus (ses) 707 may accept, connect, and/or communicate to a number of interface adapters, variously although not necessarily in the form of adapter cards, such as but not limited to any of: input output interfaces (I/O) 708, storage interfaces 709, network interfaces 710, and/or the like. Optionally, cryptographic processor interfaces 727 similarly may be connected to the interface bus. The interface bus provides for the communications of interface adapters with one another as well as with other components of the computer systemization. Interface adapters are adapted for a compatible interface bus. Interface adapters variously connect to the interface bus via a slot architecture. Various slot architectures may be employed, such as, but not limited to any of: Accelerated Graphics Port (AGP), Card Bus, (Extended) Industry Standard Architecture ((E) ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 709 may accept, communicate, and/or connect to a number of storage devices such as, but not limited to any of: (removable) storage devices 714, removable disc devices, and/or the like. Storage interfaces may employ connection protocols such as, but not limited to any of: (Ultra) (Serial) Advanced Technology Attachment (Packet Interface) ((Ultra) (Serial) ATA(PI)), (Enhanced) Integrated Drive Electronics ((E) IDE), Institute of Electrical and Electronics Engineers (IEEE®) 1394, fiber channel, Non-Volatile Memory (NVM) Express (NVMe), Small Computer Systems Interface (SCSI), Thunderbolt, Universal Serial Bus (USB), and/or the like.

Network interfaces 710 may accept, communicate, and/or connect to a communications network 713. Through a communications network 713, the CRAEML controller is accessible through remote clients 733b (e.g., computers with web browsers) by users 733a. Network interfaces may employ connection protocols such as, but not limited to any of: direct connect, Ethernet (e.g., any of: fiber, thick, thin, twisted pair 10/100/1000/10000 Base T, and/or the like), Token Ring, wireless connection such as IEEE 802.11a-y, and/or the like. Should processing requirements dictate a greater amount speed and/or capacity, distributed network controllers (e.g., see Distributed CRAEML below), architectures may similarly be employed to pool, load balance, and/or otherwise decrease/increase the communicative bandwidth required by the CRAEML controller. A communications network may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi®, Wireless Application Protocol (WAP), I-mode, and/or the like); and/or the like. A network interface may be regarded as a specialized form of an input output interface. Further, multiple network interfaces 710 may be used to engage with various communications network types 713. For example, multiple network interfaces may be employed to allow for the communication over broadcast, multicast, and/or unicast networks.

Input Output interfaces (I/O) 708 may accept, communicate, and/or connect to any of: user, peripheral devices 712 (e.g., input devices 711), cryptographic processor devices 728, and/or the like. I/O may employ connection protocols such as, but not limited to any of: audio: analog, digital, monaural, RCA, stereo, and/or the like; data: Apple Desktop Bus (ADB)®, IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) displayport, high-definition multimedia interface (HDMI), RCA, RF antennae, S-Video, Thunderbolt®/USB-C, VGA, and/or the like; wireless transceivers: 802.11a-y; Bluetooth®; cellular (e.g., code division multiple access (CDMA), high speed packet access (HSPA(+)), high-speed downlink packet access (HSDPA), global system for mobile communications (GSM), long term evolution (LTE), WiMax®, etc.); and/or the like. One output device may include a video display, which may comprise a Cathode Ray Tube (CRT), Liquid Crystal Display (LCD), Light-Emitting Diode (LED), Organic Light-Emitting Diode (OLED), and/or the like based monitor with an interface (e.g., HDMI circuitry and cable) that accepts signals from a video interface, may be used. The video interface composites information generated by a computer systemization and generates video signals based on the composited information in a video memory frame. Another output device is a television set, which accepts signals from a video interface. The video interface provides the composited video information through a video connection interface that accepts a video display interface (e.g., an RCA composite video connector accepting an RCA composite video cable; a DVI connector accepting a DVI display cable, etc.).

Peripheral devices 712 may be connected and/or communicate to I/O and/or other facilities of the like such as any of: network interfaces, storage interfaces, directly to the interface bus, system bus, the CPU, and/or the like. Peripheral devices may be external, internal and/or part of the CRAEML controller. Peripheral devices may include any of: antenna, audio devices (e.g., line-in, line-out, microphone input, speakers, etc.), cameras (e.g., gesture (e.g., Microsoft Kinect®) detection, motion detection, still, video, webcam, etc.), dongles (e.g., for copy protection ensuring secure transactions with a digital signature, as connection/format adaptors, and/or the like), external processors (for added capabilities; e.g., crypto devices 528), force-feedback devices (e.g., vibrating motors), infrared (IR) transceiver, network interfaces, printers, scanners, sensors/sensor arrays and peripheral extensions (e.g., ambient light, GPS, gyroscopes, proximity, temperature, etc.), storage devices, transceivers (e.g., cellular, GPS, etc.), video devices (e.g., goggles, monitors, etc.), video sources, visors, and/or the like. Peripheral devices often include types of input devices (e.g., cameras).

User input devices 711 often are a type of peripheral device 512 (see above) and may include any of: accelerometers, camaras, card readers, dongles, finger print readers, gloves, graphics tablets, joysticks, keyboards, microphones, mouse (mice), remote controls, security/biometric devices (e.g., facial identifiers, fingerprint reader, iris reader, retina reader, etc.), styluses, touch screens (e.g., capacitive, resistive, etc.), trackballs, trackpads, watches, and/or the like.

It should be noted that although user input devices and peripheral devices may be employed, the CRAEML controller may be embodied as an embedded, dedicated, and/or monitor-less (i.e., headless) device, and access may be provided over a network interface connection.

Cryptographic units such as, but not limited to any of: microcontrollers, processors 726, interfaces 727, and/or devices 728 may be attached, and/or communicate with the CRAEML controller. A MC68HC16 microcontroller, manufactured by Motorola, Inc.®, may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other specialized cryptographic processors include any of: Broadcom's® CryptoNetX and other Security Processors; nCipher's® nShield; SafeNet's® Luna PCI (e.g., 7100) series; Semaphore Communications'® 40 MHz Roadrunner 184; Sun's® Cryptographic Accelerators (e.g., Accelerator 6000 PCIe Board, Accelerator 500 Daughtercard); Via Nano® Processor (e.g., L2100, L2200, U2400) line, which is capable of performing 500+ MB/s of cryptographic instructions; VLSI Technology's® 33 MHz 6868; and/or the like.

### MEMORY

Generally, any mechanization and/or embodiment allowing a processor to affect the storage and/or retrieval of information is regarded as memory 729. The storing of information in memory may result in a physical alteration of the memory to have a different physical state that makes the memory a (e.g., physical) structure with a unique encoding of the memory stored therein. While memory is often physical and/or non-transitory, short term transitory memories may also be employed in various contexts, e.g., network communication may also be employed to send data as signals acting as transitory as well, for applications not requiring more long-term storage. Often, memory is a fungible technology and resource, thus, any number of memory embodiments may be employed in lieu of or in concert with one another. It is to be understood that the CRAEML controller and/or a computer systemization may employ various forms of memory 729. For example, a computer systemization may be configured to have the operation of on-chip CPU memory (e.g., registers), RAM, ROM, and any other storage devices performed by a paper punch tape or paper punch card mechanism; however, such an embodiment would result in an extremely slow rate of operation. In one configuration, memory 729 may include ROM 706, RAM 705, and a storage device 714. A storage device 714 may be any various computer system storage. Storage devices may include: an array of devices (e.g., Redundant Array of Independent Disks (RAID)); a cache memory, a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); RAM drives; register memory (e.g., in a CPU), solid state memory devices (e.g., USB memory, solid state drives (SSD), etc.); other processor-readable storage mediums; and/or other devices of the like. Thus, a computer systemization generally employs and makes use of memory.

### Component Collection

The memory 729 may contain a collection of processor-executable application/library/program and/or database components (e.g., including processor-executable instructions) and/or data such as, but not limited to any of: operating system component(s) 715 (operating system); information server component(s) 716 (information server); user interface component(s) 717 (user interface); Web browser component(s) 718 (Web browser); database(s) 719; mail server component(s) 721; mail client component(s) 722; cryptographic server component(s) 720 (cryptographic server); machine learning component 723; distributed immutable ledger component 724; the CRAEML component(s) 735 (e.g., which may include MMIP 741, and/or the like components); and/or the like (i.e., collectively referred to throughout as a “component collection”). These components may be stored and accessed from the storage devices and/or from storage devices accessible through an interface bus. Although unconventional program components such as those in the component collection may be stored in a local storage device 714, they may also be loaded and/or stored in memory such as: cache, peripheral devices, processor registers, RAM, remote storage facilities through a communications network, ROM, various forms of memory, and/or the like.

### Operating System

The operating system component 715 is an executable program component facilitating the operation of the CRAEML controller. The operating system may facilitate access to any of: I/O, network interfaces, peripheral devices, storage devices, and/or the like. The operating system may be a highly fault tolerant, scalable, and secure system such as any of: Apple's Macintosh OS X® (Server) and macOS®; AT&T® Plan 9R; Be OS®; Blackberry's QNX®; Google's Chrome®; Microsoft's Windows® Jul. 8, 2010; Unix and Unix-like system distributions (such as AT&T′s® UNIX®; Berkley Software Distribution (BSD)® variations such as FreeBSD®, NetBSD®, OpenBSD®, and/or the like; Linux® distributions such as Red Hat®, Ubuntu®, and/or the like); and/or the like operating systems. However, more limited and/or less secure operating systems also may be employed such as any of: Apple Macintosh OS® (i.e., versions 1-9), IBM OS/2®,Microsoft DOS®, Microsoft Windows® 2000/2003/3.1/95/98/CE/Millennium/Mobile/NT/Vista/XP/7/X (Server)®, Palm OS®, and/or the like. Additionally, for robust mobile deployment applications, mobile operating systems may be used, such as any of: Apple's iOS®; China Operating System COS®; Google's Android®; Microsoft® Windows® RT/PhoneR; Palm's WebOS®; Samsung®/Intel's Tizen®; and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may facilitate the interaction with any of: communications networks, data, I/O, peripheral devices, program components, memory, user input devices, and/or the like. The operating system may provide communications protocols that allow the CRAEML controller to communicate with other entities through a communications network 713. Various communication protocols may be used by the CRAEML controller as a subcarrier transport mechanism for interaction, such as, but not limited to any of: multicast, TCP/IP, UDP, unicast, and/or the like.

### Information Server

An information server component 716 is a stored program component that is executed by a CPU. The information server may be an Internet information server such as, but not limited to any of: Apache Software Foundation's Apache®, Microsoft's Internet Information Server®, and/or the like. The information server may allow for the execution of program components through facilities such as any of: Active Server Page (ASP), ActiveX, (ANSI) (Objective-) C(++), C# and/or.NET®, Common Gateway Interface (CGI) scripts, dynamic (D) hypertext markup language (HTML), FLASH®, Java®, JavaScript®, Practical Extraction Report Language (PERL)®, Hypertext Pre-Processor (PHP), pipes, Python®, Ruby, wireless application protocol (WAP), WebObjects®, and/or the like. The information server may support secure communications protocols such as, but not limited to any of: File Transfer Protocol (FTP(S)); HyperText Transfer Protocol (HTTP); Secure Hypertext Transfer Protocol (HTTPS), Secure Socket Layer (SSL) Transport Layer Security (TLS), messaging protocols (e.g., America Online (AOL®) Instant Messenger (AIM)®, Application Exchange (APEX), ICQ, Internet Relay Chat (IRC), Microsoft Network (MSN) Messenger® Service, Presence and Instant Messaging Protocol (PRIM), Internet Engineering Task Force's® (IETF's) Session Initiation Protocol (SIP), SIP for Instant Messaging and Presence Leveraging Extensions (SIMPLE), Slack®, open XML-based Extensible Messaging and Presence Protocol (XMPP) (i.e., Jabber® or Open Mobile Alliance's (OMA's) Instant Messaging and Presence Service (IMPS)), Yahoo! Instant Messenger® Service, and/or the like). The information server may provide results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the CRAEML controller based on the remainder of the HTTP request. For example, a request such as http://followed by the address, e.g., 123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with any of: the CRAEML database 719, operating systems, other program components, user interfaces, Web browsers, and/or the like.

Access to the CRAEML database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the CRAEML. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in SQL by instantiating a search string with the proper join/select commands based on the tagged text entries, and the resulting command is provided over the bridge mechanism to the CRAEML as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as buttons, check boxes, cursors, graphical views, menus, scrollers, text fields, and windows (collectively referred to as widgets) similarly facilitate the access, capabilities, operation, and display of data and computer hardware and operating system resources, and status. Operation interfaces are called user interfaces. Graphical user interfaces (GUIs) such as the Apple's iOS®, Macintosh Operating System's Aqua®; IBM's OS/2®;Google's Chrome® (e.g., and other webbrowser/cloud based client OSs); Microsoft's Windows® 2000/2003/3.1/95/98/CE/Millennium/Mobile/NT/Vista/XP/7/X (Server)® (i.e., Aero, Surface, etc.); Unix's X-Windows (e.g., which may include additional Unix graphic interface libraries and layers such as K Desktop Environment (KDE)®, mythTV and GNU Network Object Model Environment (GNOME))®, web interface libraries (e.g., ActiveX®, AJAX, (D) HTML, FLASH®, Java®, JavaScript®, etc. interface libraries such as, but not limited to any of: Dojo, jQuery (UI), MooTools, Prototype, script.aculo.us, SWFObject, Yahoo! User Interface®, and/or the like, any of which may be used and) provide a baseline and mechanism of accessing and displaying information graphically to users.

A user interface component 717 is a stored program component that is executed by a CPU. The user interface may be a graphic user interface as provided by, with, and/or atop operating systems and/or operating environments, and may provide executable library APIs (as may operating systems and the numerous other components noted in the component collection) that allow instruction calls to generate user interface elements such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 718 is a stored program component that is executed by a CPU. The Web browser may be a hypertext viewing application such as any of: Apple's (mobile) Safari®, Brave Software, Inc.'s Brave Browser (including Virtual Private Network (VPN) features), Google's Chrome®, Microsoft Edge®, Microsoft Internet Explorer®, Mozilla's Firefox®, Netscape Navigator®, The Tor Project, Inc,'s Tor Browser® (including VPN features), and/or the like. Secure Web browsing may be supplied with 128 bit (or greater) encryption by way of HTTPS, SSL, and/or the like. Web browsers allowing for the execution of program components through facilities such as any of: ActiveX®, AJAX, (D) HTML, FLASH®, Java®, JavaScript®, web browser plug-in APIs (e.g., FireFox®, Safari® Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with any of: information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the CRAEML enabled nodes. The combined application may be nugatory on systems employing Web browsers.

### Mail Server

A mail server component 721 is a stored program component that is executed by a CPU 703. The mail server may be an Internet mail server such as, but not limited to any of: dovecot, Courier IMAP, Cyrus IMAP, Maildir, Microsoft Exchange®, sendmail, and/or the like. The mail server may allow for the execution of program components through facilities such as any of: ASP, ActiveX®, (ANSI) (Objective-) C(++), C# and/or.NET, CGI scripts, Java®, JavaScript®, PERL®, PHP, pipes, Python®, WebObjects®, and/or the like. The mail server may support communications protocols such as, but not limited to any of: Internet message access protocol (IMAP), Messaging Application Programming Interface (MAPI)/Microsoft Exchange®, post office protocol (POP3), simple mail transfer protocol (SMTP), and/or the like. The mail server can route, forward, and process incoming and outgoing mail messages that have been sent, relayed and/or otherwise traversing through and/or to the CRAEML. Alternatively, the mail server component may be distributed out to mail service providing entities such as Google's® cloud services (e.g., Gmail® and notifications may alternatively be provided via messenger services such as AOL's Instant Messenger®, Apple's iMessage®, Google Messenger®, SnapChat®, etc.).

Access to the CRAEML mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 722 is a stored program component that is executed by a CPU 703. The mail client may be a mail viewing application such as any of: Apple Mail®, Microsoft Entourage®, Microsoft Outlook®, Microsoft Outlook Express®, Mozilla®, Thunderbird®, and/or the like. Mail clients may support a number of transfer protocols, such as any of: IMAP, Microsoft Exchange®, POP3, SMTP, and/or the like. A mail client may communicate to and/or with other components in a component collection, including itself, and/or facilities of the like. Most frequently, the mail client communicates with ay of: mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 720 is a stored program component that is executed by any of: a CPU 703, cryptographic processor 726, cryptographic processor interface 727, cryptographic processor device 728, and/or the like. Cryptographic processor interfaces may allow for expedition of encryption and/or decryption requests by the cryptographic component; however, the cryptographic component, alternatively, may run on a CPU and/or GPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to any of: digital certificates (e.g., X.509 authentication framework), digital signatures, dual signatures, enveloping, password access protection, public key management, and/or the like. The cryptographic component facilitates numerous (encryption and/or decryption) security protocols such as, but not limited to any of: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), Transport Layer Security (TLS), and/or the like. Employing such encryption security protocols, the CRAEML may encrypt all incoming and/or outgoing communications and may serve as node within a virtual private network (VPN) with a wider communications network. The cryptographic component facilitates the process of “security authorization” whereby access to a resource is inhibited by a security protocol and the cryptographic component effects authorized access to the secured resource. In addition, the cryptographic component may provide unique identifiers of content, e.g., employing an MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to allow the CRAEML component to engage in secure transactions if so desired. The cryptographic component facilitates the secure accessing of resources on the CRAEML and facilitates the access of secured resources on remote systems; i.e., it may act as a client and/or server of secured resources. Most frequently, the cryptographic component communicates with any of: information servers, operating systems, other program components, and/or the like. The cryptographic component may contain, communicate, generate, obtain, and/or provide program component, system, user, and/or data communications, requests, and/or responses.

### Machine Learning (ML)

In one non limiting embodiment, the CRAEML includes a machine learning component 723, which may be a stored program component that is executed by a CPU 703. The machine learning component, alternatively, may run on any of: a set of specialized processors, ASICs, FPGAs, GPUs, and/or the like. The machine learning component may be deployed to execute serially, in parallel, distributed, and/or the like, such as by utilizing cloud computing. The machine learning component may employ an ML platform such as any of: Amazon SageMaker, Azure® Machine Learning, DataRobot AI Cloud, Google AI Platform, IBM Watson® Studio, and/or the like. The machine learning component may be implemented using any of: an ML framework such as any of: PyTorch, Apache MXNet, MathWorks Deep Learning Toolbox, scikit-learn, TensorFlow, XGBoost, and/or the like. The machine learning component facilitates training and/or testing of ML prediction logic data structures (e.g., models) and/or utilizing ML prediction logic data structures (e.g., models) to output ML predictions by the CRAEML. The machine learning component may employ various artificial intelligence and/or learning mechanisms such as any of: Reinforcement Learning, Supervised Learning, Unsupervised Learning, and/or the like. The machine learning component may employ ML prediction logic data structure (e.g., model) types such as any of: Bayesian Networks, Classification prediction logic data structures (e.g., models), Decision Trees, Neural Networks (NNs), Regression prediction logic data structures (e.g., models), and/or the like.

### Distributed Immutable Ledger (DIL)

In one non limiting embodiment, the CRAEML includes a distributed immutable ledger component 724, which may be a stored program component that is executed by a CPU 703. The distributed immutable ledger component, alternatively, may run on any of: a set of specialized processors, ASICs, FPGAs, GPUs, and/or the like. The distributed immutable ledger component may be deployed to execute as any of: serially, in parallel, distributed, and/or the like, such as by utilizing a peer-to-peer network. The distributed immutable ledger component may be implemented as a blockchain (e.g., public blockchain, private blockchain, hybrid blockchain) that comprises cryptographically linked records (e.g., blocks). The distributed immutable ledger component may employ a platform such as any of: Bitcoin, Bitcoin Cash, Dogecoin, Ethereum,

Litecoin, Monero, Zcash, and/or the like. The distributed immutable ledger component may employ a consensus mechanism such as any of: proof of authority, proof of space, proof of stake, proof of work, and/or the like. The distributed immutable ledger component may be used to provide mechanisms such as any of: data storage, cryptocurrency, inventory tracking, non-fungible tokens (NFTs), smart contracts, and/or the like.

### The CRAEML Database

The CRAEML database component 719 may be embodied in a database and its stored data. The database is a stored program component, which is executed by the CPU; the stored program component portion configuring the CPU to process the stored data. The database may be a fault tolerant, relational, scalable, secure database such as any of: Claris FileMaker®, MySQL®, Oracle®, Sybase®, etc. may be used. Additionally, optimized fast memory and distributed databases such as any of: IBM's Netezza®, MongoDB's MongoDB®, opensource Hadoop®, opensource VoltDB, SAP's Hana®, etc. Relational databases are an extension of a flat file. Relational databases include a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. Alternative key fields may be used from any of the fields having unique value sets, and in some alternatives, even non-unique values in combinations with other fields. More precisely, they uniquely identify rows of a table on the “one” side of a one-to-many relationship.

Alternatively, the CRAEML database may be implemented using various other data-structures, such as any of: an array, hash, (linked) list, struct, structured text file (e.g., JSON, XML, and/or the like), table, flat file database, and/or the like. Such data-structures may be stored in memory and/or in (structured) files. In another alternative, an object-oriented database may be used, such as any of: Frontier™, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the CRAEML database is implemented as a data-structure, the use of the CRAEML database 719 may be integrated into another component such as the CRAEML component 735. Also, the database may be implemented as a mix of data structures, objects, programs, relational structures, scripts, and/or the like. Databases may be consolidated and/or distributed in countless variations (e.g., see Distributed CRAEML below). Portions of databases, e.g., tables, may be exported and/or imported and thus decentralized and/or integrated.

In another embodiment, the database component (and/or other storage mechanism of the CRAEML) may store data immutably so that tampering with the data becomes physically impossible and the fidelity and security of the data may be assured. In some embodiments, the database may be stored to write only or write once, read many (WORM) mediums. In another embodiment, the data may be stored on distributed ledger systems (e.g., via blockchain) so that any tampering to entries would be readily identifiable. In one embodiment, the database component may employ the distributed immutable ledger component DIL 724 mechanism.

In one embodiment, the database component 719 includes several tables representative of the schema, tables, structures, keys, entities and relationships of the described database 719a-z:

An accounts table 719a includes fields such as, but not limited to any of: an accountID, accountOwnerID, accountContactID, assetIDs, deviceIDs, paymentIDs, transactionIDs, userIDs, accountType (e.g., agent, entity (e.g., corporate, non-profit, partnership, etc.), individual, etc.), accountCreationDate, accountUpdateDate, accountName, accountNumber, routingNumber, link WalletsID, accountPrioritAccaountRatio, accountAddress, accountState, accountZIPcode, accountCountry, accountEmail, accountPhone, accountAuthKey, accountIPaddress, accountURLAccessCode, accountPortNo, accountAuthorizationCode, accountAccessPrivileges, accountPreferences, accountRestrictions, and/or the like;

A users table 719b includes fields such as, but not limited to any of: a userID, userSSN, taxID, userContactID, accountID, assetIDs, deviceIDs, paymentIDs, transactionIDs, userType (e.g., agent, entity (e.g., corporate, non-profit, partnership, etc.), individual, etc.), namePrefix, firstName, middleName, lastName, nameSuffix, DateOfBirth, userAge, userName, userEmail, userSocialAccountID, reputationScore, contactType, contactRelationship, userPhone, userAddress, userCity, userState, userZIPCode, userCountry, userAuthorizationCode, userAccessPrivilges, userPreferences, userRestrictions, and/or the like (the user table may support and/or track multiple entity accounts on a CRAEML);

An devices table 719c includes fields such as, but not limited to any of: deviceID, sensorIDs, accountID, assetIDs, paymentIDs, deviceType, deviceName, deviceManufacturer, deviceModel, device Version, deviceSerialNo, deviceIPaddress, deviceMACaddress, device_ECID, deviceUUID, deviceLocation, deviceCertificate, deviceOS, appIDs, deviceResources, deviceSession, authKey, deviceSecureKey, walletAppInstalledFlag, deviceAccessPrivileges, devicePreferences, deviceRestrictions, hardware_config, software_config, storage_location, sensor_value, pin_reading, data_length, channel_requirement, sensor_name, sensor_model_no, sensor_manufacturer, sensor_type, sensor_serial_number, sensor_power_requirement, device_power_requirement, location, sensor_associated_tool, sensor_dimensions, device_dimensions, sensor_communications_type, device_communications_type, power_percentage, power_condition, temperature_setting, speed_adjust, hold_duration, part_actuation, and/or the like. Device table may, in some embodiments, include fields corresponding to one or more Bluetooth® profiles, such as those published at www.bluetooth.org/en-us/specification/adopted-specifications, and/or other device specifications, and/or the like;

An apps table 719d includes fields such as, but not limited to any of: appID, appName, appType, appDependencies, accountID, deviceIDs, transactionID, userID, appStoreAuthKey, appStoreAccountID, appStoreIPaddress, appStoreURLaccessCode, appStorePortNo, appAccessPrivileges, appPreferences, appRestrictions, portNum, access_API_call, linked_wallets_list, and/or the like;

An assets table 719e includes fields such as, but not limited to any of: assetID, accountID, userID, distributorAccountID, distributorPaymentID, distributorOnwerID, assetOwnerID, assetType, assetSourceDeviceID, assetSourceDeviceType, assetSourceDeviceName, assetSourceDistributionChannelID, assetSourceDistributionChannelType, assetSourceDistributionChannelName, assetTargetChannelID, assetTargetChannelType, assetTargetChannelName, assetName, assetSeriesName, assetSeriesSeason, assetSeriesEpisode, assetCode, assetQuantity, assetCost, assetPrice, assetValue, assetManufactuer, assetModelNo, assetSerialNo, assetLocation, assetAddress, assetState, assetZIPcode, assetState, assetCountry, assetEmail, assetGarbageCollected, assetIPaddress, assetURLaccessCode, assetOwnerAccountID, subscriptionIDs, assetAuthroizationCode, assetAccessPrivileges, assetPreferences, assetRestrictions, assetAPI, assetAPIconnectionAddress, and/or the like;

A payments table 719f includes fields such as, but not limited to any of: paymentID, accountID, userID, couponID, coupon Value, couponConditions, couponExpiration, paymentType, paymentAccountNo, paymentAccountName, paymentAccountAuthorizationCodes, paymentExpirationDate, paymentCCV, paymentRoutingNo, paymentRoutingType, paymentAddress, paymentState, paymentZIPcode, paymentCountry, paymentEmail, paymentAuthKey, paymentIPaddress, paymentURLaccessCode, paymentPortNo, paymentAccessPrivileges, paymentPreferences, payementRestrictions, and/or the like;

An transactions table 719g includes fields such as, but not limited to any of: transactionID, accountID, assetIDs, deviceIDs, paymentIDs, transactionIDs, userID, merchantID, transactionType, transactionDate, transactionTime, transactionAmount, transactionQuantity, transactionDetails, productsList, product Type, productTitle, productsSummary, productParamsList, transactionNo, transaction AccessPrivileges, transactionPreferences, transactionRestrictions, merchantAuthKey, merchantAuthCode, and/or the like;

An merchants table 719h includes fields such as, but not limited to any of: merchantID, merchantTaxID, merchanteName, merchantContactUserID, accountID, issuerID, acquirerID, merchantEmail, merchantAddress, merchantState, merchantZIPcode, merchantCountry, merchantAuthKey, merchantIPaddress, portNum, merchantURLaccessCode, merchantPortNo, merchantAccessPrivileges, merchantPreferences, merchantRestrictions, and/or the like;

An ads table 719i includes fields such as, but not limited to any of: adID, advertiserID, adMerchantID, adNetworkID, adName, adTags, advertiserName, adSponsor, adTime, adGeo, adAttributes, adFormat, adProduct, adText, adMedia, adMediaID, adChannelID, adTagTime, adAudioSignature, adHash, adTemplateID, adTemplateData, adSourceID, adSourceName, adSourceServerIP, adSourceURL, adSourceSecurityProtocol, adSourceFTP, adAuthKey, adAccessPrivileges, adPreferences, adRestrictions, adNetworkXchangeID, adNetworkXchangeName, adNetworkXchangeCost, adNetworkXchangeMetricType (e.g., CPA, CPC, CPM, CTR, etc.), adNetwork XchangeMetric Value, adNetwork XchangeServer, adNetworkXchangePortNumber, publisherID, publisherAddress, publisherURL, publisherTag, publisherIndustry, publisherName, publisherDescription, siteDomain, siteURL, siteContent, siteTag, siteContext, siteImpression, siteVisits, siteHeadline, sitePage, siteAdPrice, sitePlacement, sitePosition, bidID, bidExchange, bidOS, bidTarget, bidTimestamp, bidPrice, bidImpressionID, bidType, bidScore, adType (e.g., mobile, desktop, wearable, largescreen, interstitial, etc.), assetID, merchantID, deviceID, userID, accountID, impressionID, impressionOS, impression TimeStamp, impressionGeo, impressionAction, impression Type, impressionPublisherID, impressionPublisherURL, and/or the like;

An ML table 719j includes fields such as, but not limited to any of: MLID, predictionLogicStructureID, predictionLogicStructureType, predictionLogicStructureTrainedStructure, predictionLogicStructureConfiguration, predictionLogicStructure TrainingData, predictionLogicStructure TrainingDataConfiguration, predictionLogicStructure TestingData, predictionLogicStructureTestingDataConfiguration, predictionLogicStructureOutputData, predictionLogicStructureOutputDataConfiguration, and/or the like;

A cases table 719k includes fields such as, but not limited to any of: caseID, caseType, associated VenueIDs (e.g., court, judge), case Status (e.g., current milestone), caseMilestoneDocuments, caseResolutionDocuments, caseFeedback, and/or the like;

A templates table 719l includes fields such as, but not limited to any of: templateID, templateType, templateSubtype, templateContent, templatePlaceholders, and/or the like;

A venues table 719k includes fields such as, but not limited to any of: venueID, venueType, venueState, venueAddress, venueCourtDetails, venueJudgeDetails, associatedCaseData, and/or the like;

A market_data table 719z includes fields such as, but not limited to any of: market data feed_ID, asset_ID, asset_symbol, asset_name, spot price, bid price, ask price, and/or the like; in one embodiment, the market data table is populated through a market data feed (e.g., Bloomberg's PhatPipe®, Consolidated Quote System® (CQS), Consolidated Tape Association® (CTA), Consolidated Tape System® (CTS), Dun & Bradstreet®, OTC Montage Data Feed® (OMDF), Reuter's Tib®, Triarch®, US equity trade and quote market data®, Unlisted Trading Privileges® (UTP) Trade Data Feed® (UTDF), UTP Quotation Data Feed® (UQDF), and/or the like feeds, e.g., via ITC 2.1 and/or respective feed protocols), for example, through Microsoft's® Active Template Library and Dealing Object Technology's real-time toolkit Rtt.Multi.

In one embodiment, the CRAEML database may interact with other database systems. For example, employing a distributed database system, queries and data access by search CRAEML component may treat the combination of the CRAEML database, an integrated data security layer database as a single database entity (e.g., see Distributed CRAEML below).

In one embodiment, user programs may contain various user interface primitives, which may serve to update the CRAEML. Also, various accounts may require custom database tables depending upon the environments and the types of clients the CRAEML may need to serve. It should be noted that any unique fields may be designated as a key field throughout. In an alternative embodiment, these tables have been decentralized into their own databases and their respective database controllers (i.e., individual database controllers for each of the above tables). The CRAEML may also be configured to distribute the databases over several computer systemizations and/or storage devices. Similarly, configurations of the decentralized database controllers may be varied by consolidating and/or distributing the various database components 719a-z. The CRAEML may be configured to keep track of various settings, inputs, and parameters via database controllers.

The CRAEML database may communicate to and/or with other components in a component collection, including itself, and/or facilities of the like. Most frequently, the CRAEML database communicates with any of: the CRAEML component, other program components, and/or the like. The database may contain, retain, and provide information regarding other nodes and data.

### The CRAEMLs

The CRAEML component 735 is a stored program component that is executed by a CPU via stored instruction code configured to engage signals across conductive pathways of the CPU and ISICI controller components. In one embodiment, the CRAEML component incorporates any and/or all combinations of the aspects of the CRAEML that were discussed in the previous figures. As such, the CRAEML affects accessing, obtaining and the provision of information, services, transactions, and/or the like across various communications networks. The features and embodiments of the CRAEML discussed herein increase network efficiency by reducing data transfer requirements with the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., may reduce the capacity and structural infrastructure requirements to support the CRAEML's features and facilities, and in many cases reduce the costs, energy consumption/requirements, and extend the life of CRAEML's underlying infrastructure; this has the added benefit of making the CRAEML more reliable. Similarly, many of the features and mechanisms are designed to be easier for users to use and access, thereby broadening the audience that may enjoy/employ and exploit the feature sets of the CRAEML; such ease of use also helps to increase the reliability of the CRAEML. In addition, the feature sets include heightened security as noted via the Cryptographic components 720, 726, 728 and throughout, making access to the features and data more reliable and secure

The CRAEML transforms matter milestone interaction input datastructure/inputs, via CRAEML components (e.g., MMIP), into matter milestone interaction output outputs.

The CRAEML component facilitates access of information between nodes may be developed by employing various development tools and languages such as, but not limited to any of: Apache® components, Assembly, ActiveX, binary executables, (ANSI) (Objective-) C (++), C# and/or.NET®, database adapters, CGI scripts, Java®, JavaScript®, mapping tools, procedural and object oriented development tools, PERL®, PHP, Python®, Ruby, shell scripts, SQL commands, web application server extensions, web development environments and libraries (e.g., Microsoft's® ActiveX®; Adobe AIR®, FLEX & FLASH®; AJAX;(D) HTML; Dojo, Java®; JavaScript®; jQuery(UI); MooTools; Prototype; script.aculo.us; Simple Object Access Protocol (SOAP); SWFObject; Yahoo!® User Interface; and/or the like), WebObjects®, and/or the like. In one embodiment, the CRAEML server employs a cryptographic server to encrypt and decrypt communications. The CRAEML component may communicate to and/or with other components in a component collection, including itself, and/or facilities of the like. Most frequently, the CRAEML component communicates with any of: the CRAEML database, operating systems, other program components, and/or the like. The CRAEML may contain, communicate, generate, obtain, and/or provide program component, system, user, and/or data communications, requests, and/or responses.

### Distributed CRAEMLs

The structure and/or operation of any of the CRAEML node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion. As such, a combination of hardware may be distributed within a location, within a region and/or globally where logical access to a controller may be abstracted as a singular node, yet where a multitude of private, semiprivate and publicly accessible node controllers (e.g., via dispersed data centers) are coordinated to serve requests (e.g., providing private cloud, semi-private cloud, and public cloud computing resources) and allowing for the serving of such requests in discrete regions (e.g., isolated, local, regional, national, global cloud access, etc.).

Thus, CRAEML may be implemented with varying functional, logical, operational, organizational, structural and/or topological modifications may be made without departing from the scope and/or spirit of the disclosure. For example, unless expressly described otherwise, it is to be understood that the logical and/or topological structure of any combination of any program components (e.g., of the component collection), other components, data flow order, logic flow order, and/or any present feature sets as described in the figures and/or throughout are not limited to a fixed operating order and/or arrangement, but rather, any disclosed order is exemplary (e.g., such description may be presented as such for ease of description and understanding of disclosed principles) and all equivalents, and the components may execute at the same or different processors and in varying orders. Furthermore, it is to be understood that such features are not limited to serial execution (e.g., such description may be presented as such for ease of description and understanding of disclosed principles), but rather, any number of threads, processes, services, servers, and/or the like that may execute asymmetrically, asynchronously, batch, concurrently, delayed, dynamically, in parallel, on-demand, periodically, real-time, symmetrically, simultaneously, synchronously, triggered, and/or the like may take place depending on how the components and even individual methods and/or functions are called. For example, in any of the dataflow and/or logic flow descriptions, any individual item and/or method and/or function called may only execute serially and/or asynchronously in a small deployment on a single core machine, but may be executed concurrently, in parallel, simultaneously, synchronously (as well as asynchronously yet still concurrent, in parallel, and/or simultaneously) when deployed on multicore processors or even across multiple machines and in and from multiple machines and geographic regions.

As such, the component collection may be consolidated and/or distributed in countless variations through various data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so as discussed through the disclosure and/or through various other data processing communication techniques. Furthermore, any part or sub parts of the CRAEML node controller's component collection (and/or any constituent processing instructions) may be executed on at least one processing unit, where that processing unit may be a sub-unit of a CPU, a core, an entirely different CPU and/or sub-unit at the same location or remotely at a different location, and/or across many multiple such processing units. For example, for load-balancing reasons, parts of the component collection may start to execute on a given CPU core, then the next instruction/execution element of the component collection may (e.g., be moved to) execute on another CPU core, on the same, or completely different CPU at the same or different location, e.g., because the CPU may become over taxed with instruction executions, and as such, a scheduler may move instructions at the taxed CPU and/or CPU sub-unit to another CPU and/or CPU sub-unit with a lesser instruction execution load. In another embodiment, processing may take place on hosted virtual machines such as on Amazon® Data/Web Services (AWS)® where virtual machines literally do not even exist while CRAEML is executing, and as processing demands increase, such additional virtual machines may be spun up and instantiated as necessary and created on-the-fly to increase processing throughput (e.g., by distributing processing of CRAEML component collection processor instructions), and conversely, virtual machines may be spun down and cease to exist as processing demands decrease; these virtual machines may be spun up/down on the same, or in completely remote and physically separate facilities and hardware. As such, it may be difficult and/or impossible to predict on which CPU, processing sub-unit, and/or virtual machine a process instruction begins execution and where it will continue and/or conclude execution, as it may be on the same and/or completely different CPU, processing sub-unit, virtual machine, and/or the like.

The configuration of the CRAEML controller may depend on the context of system deployment. Factors such as, but not limited to any of: the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to any of: data referencing (e.g., pointers), internal messaging, object instance variable communication, shared memory space, variable passing, and/or the like. For example, cloud services such as any of: Amazon Data/Web Services®, Microsoft Azure®, Hewlett Packard Helion®, IBM® Cloud services allow for CRAEML controller and/or CRAEML component collections to be hosted in full or partially for varying degrees of scale.

If component collection components are discrete, separate, and/or external to one another, then communicating, obtaining, and/or providing data with and/or to other component components may be accomplished through inter-application data processing communication techniques such as, but not limited to any of: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON)®, NeXT Computer, Inc.'s® (Dynamic) Object Linking, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as any of: JSON, lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to any of: character (e.g., tab) delineated text, HTML, JSON, structured text streams, XML, and/or the like structured data. In another embodiment, inter-application data processing protocols themselves may have integrated parsers (e.g., JSON, SOAP, and/or like parsers) that may be employed to parse (e.g., communications) data. Further, the parsing grammar may be used beyond message parsing, but may also be used to parse any of: databases, data collections, data stores, structured data, and/or the like. Again, the desired configuration may depend upon the context, environment, and requirements of system deployment.

For example, in some implementations, the CRAEML controller may be executing a PHP script implementing a Secure Sockets Layer (“SSL”) socket server via the information server, which it listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via an SSL connection, parse the data to extract variables, and store the data to a database, is provided below:

```
<?PHP
header (′Content-Type: text/plain′);
// set ip address and port to listen to for incoming data
$address = ′192.168.0.100′;
$port = 255;
// create a server-side SSL socket, listen for/accept incoming
communication
$sock = socket_create (AF_INET, SOCK_STREAM, 0);
socket_bind ($sock, $address, $port) or die (′Could not bind to address′);
socket_listen ($sock);
$client = socket_accept ($sock);
// read input data from client device in 1024 byte blocks until end of
message
do {
  $input = ″″;
  $input = socket_read ($client, 1024);
  $data .= $input;
} while ($input != ″″);
// parse data to extract variables
$obj = json_decode ($data, true);
// store input data in a database
mysql_connect (″201.408.185.132″ ,$DBserver, $password); // access
database server
mysql_select(″CLIENT_DB.SQL″); // select database to append
mysql_query(″INSERT INTO UserTable (transmission)
VALUES ($data)″); // add data to UserTable table in a CLIENT database
mysql_close (″CLIENT_DB.SQL″); // close connection to database
?>
```

Also, the following resources may be used to provide example embodiments regarding SOAP parser implementation:

www.xav.com/perl/site/lib/SOAP/Parser.html
publib.boulder.ibm.com/infocenter/tivihelp/v2r1/index.jsp?topic=/com.ibm.
IBMDI.doc/referenceguide295.htm

and other parser implementations:

publib.boulder.ibm.com/infocenter/tivihelp/v2r1/index.jsp?topic=/com.ibm.
IBMDI.doc/referenceguide259.htm

all of which are hereby expressly incorporated by reference.

In order to address various issues and advance the art, the entirety of this application for Controversy Resolution Assistant Engine Machine Learning Apparatuses, Processes and Systems (including the Cover Page, Title, Headings, Field, Background, Summary, Brief Description of the Drawings, Detailed Description, Claims, Abstract, Figures, Appendices, and otherwise) shows, by way of illustration, various non-limiting example embodiments in which the claimed innovations may be practiced. The advantages and features described in the application are of a representative sample of embodiments only, and are not exhaustive and/or exclusive. They are presented to assist in understanding and teach the claimed principles. It should be noted that to the extent any financial and/or investment examples are included, such examples are for illustrative purpose(s) only, and are not, nor should they be interpreted, as investment advice. As such, all examples and/or embodiments are deemed to be non-limiting throughout this disclosure; it should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It may be appreciated that many of those undescribed embodiments incorporate and/or be based of same principles of the innovations and others are equivalent. As such, no inference should be drawn regarding those embodiments discussed herein relative to those not discussed herein other than it is as such for purposes of reducing space and repetition. Consequently, terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should not be construed to limit embodiments, and instead, again, are offered for convenience of description of orientation and/or convenience of reference, and as such, do not require that any embodiments be constructed or operated in a particular orientation unless explicitly indicated as such. Terms such as “attached”, “affixed”, “connected”, “coupled”, “interconnected”, etc. may refer to a relationship where structures are secured or attached to one another either directly or indirectly through intervening structures, as well as both movable or rigid attachments or relationships, unless expressly described otherwise. Similarly, descriptions of embodiments disclosed throughout this disclosure, any reference to direction or orientation is merely intended for convenience of description and/or of reference and is not intended in any way to limit the scope of described embodiments. Furthermore, it is to be understood, unless expressly described otherwise, that other embodiments may be utilized and functional, logical, operational, organizational, structural and/or topological modifications may be made without departing from the scope and/or spirit of the disclosure. For instance, unless expressly described otherwise, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Also, it is to be understood, unless expressly described otherwise, that such features are not limited to serial execution, but rather, any number of threads, processes, services, servers, and/or the like that may execute asymmetrically, asynchronously, batch, concurrently, delayed, dynamically, in parallel, on-demand, periodically, real-time, symmetrically, simultaneously, synchronously, triggered, and/or the like are contemplated by the disclosure (e.g., see Distributed CRAEML, above, for examples). Consequently, some of these features may be mutually contradictory, in that they cannot be simultaneously present in a single embodiment. Similarly, some features may be applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations-in-part, divisions, provisionals, re-issues, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a CRAEML individual and/or enterprise user, component, database configuration and/or relational model, data type, data transmission and/or network framework, feature, library, syntax structure, and/or the like, various embodiments of the CRAEML, may be implemented that allow a great deal of flexibility and customization. While various embodiments and discussions of the CRAEML have included machine learning, however, it is to be understood that the embodiments described herein may be readily configured and/or customized for a wide variety of other applications and/or implementations. For example, aspects of the CRAEML also may be adapted for legal licensing, and/or the like.

What is claimed is:

1. A resolution document generating apparatus, comprising:
at least one memory;
a component collection stored in the at least one memory;
any of at least one processor disposed in communication with the at least one memory, the any of at least one processor executing processor-executable instructions from the component collection, the component collection storage structured with processor-executable instructions comprising:
obtain, via any of at least one processor, a matter milestone interaction request datastructure, in which the matter milestone interaction request datastructure is structured as specifying a milestone document associated with a matter;
determine, via any of at least one processor, milestone document details associated with the milestone document via a natural language processing engine;
evaluate, via any of at least one processor, via a first machine learning prediction logic datastructure, the milestone document details with respect to matter data associated with the matter to determine relevant matter data;
determine, via any of at least one processor, a set of similar prior matters that are similar to the matter by executing a search query;
evaluate, via any of at least one processor, via a second machine learning prediction logic datastructure, the milestone document details, the relevant matter data and similar prior matters data associated with the set of similar prior matters with respect to resolution document templates to determine a first best matching resolution document template for the milestone document;
provide, via any of at least one processor, a prompt to a large language model to instruct the large language model to generate a set of template placeholder values for a template placeholder of the first best matching resolution document template;
obtain, via any of at least one processor, user selection of a template placeholder value to utilize from the set of template placeholder values; and
composite, via any of at least one processor, content of the first best matching resolution document template and the selected template placeholder value to utilize to generate a resolution document.

2. The apparatus of claim 1, in which the matter milestone interaction request datastructure is generated via a large language model chatbot.

3. The apparatus of claim 1, in which the milestone document details comprise at least one of: a source of the milestone document, a date associated with the milestone document, subject matter discussed in the milestone document, sentiment of the milestone document, a document reference, a venue reference.

4. The apparatus of claim 1, in which the first machine learning prediction logic datastructure and the second machine learning prediction logic datastructure are implemented via any of: Bayesian network, classification prediction logic datastructure, decision tree, neural network, regression prediction logic datastructure.

5. The apparatus of claim 1, in which the search query specifies a matter type of the matter as a search query parameter.

6. The apparatus of claim 1, in which the search query specifies a venue associated with the matter as a search query parameter.

7. The apparatus of claim 1, in which the search query specifies at least some of the relevant matter data as a search query parameter.

8. The apparatus of claim 1, in which the search query is executed via a large language model search.

9. The apparatus of claim 1, in which the first best matching resolution document template is calculated to have a high likelihood of producing a successful outcome with regard to the milestone document.

10. The apparatus of claim 1, in which the prompt is structured to comprise instructions to construct template placeholder values that maximize likelihood of producing a successful outcome with regard to the milestone document.

11. The apparatus of claim 1, in which the user selection of the template placeholder value to utilize is obtained via a large language model chatbot.

12. The apparatus of claim 1, in which the component collection storage is further structured with processor-executable instructions comprising:
provide, via any of at least one processor, the generated resolution document.

13. The apparatus of claim 12, in which the instructions to provide the generated resolution document are structured as instructions to file the generated resolution document with a venue.

14. The apparatus of claim 12, in which the component collection storage is further structured with processor-executable instructions comprising:
obtain, via any of at least one processor, feedback with regard to the provided resolution document; and
datastructure via training data comprising the feedback.

15. The apparatus of claim 1, in which the component collection storage is further structured with processor-executable instructions comprising:
obtain, via any of at least one processor, user selection of a venue to utilize for the resolution document;
calculate, via any of at least one processor, a first likelihood of producing a successful outcome with regard to the milestone document in the selected venue for the resolution document;
determine, via any of at least one processor, that a second best matching resolution document template exists for the milestone document in the selected venue, in which the second best matching resolution document template has a calculated second likelihood of producing a successful outcome with regard to the milestone document in the selected venue that is higher than the calculated first likelihood; and
generate, via any of at least one processor, an alternative resolution document via the second best matching resolution document template.

16. A resolution document generating processor-readable, non-transient medium, the medium storing a component collection, the component collection storage structured with processor-executable instructions comprising:
obtain, via any of at least one processor, a matter milestone interaction request datastructure, in which the matter milestone interaction request datastructure is structured as specifying a milestone document associated with a matter;
determine, via any of at least one processor, milestone document details associated with the milestone document via a natural language processing engine;
evaluate, via any of at least one processor, via a first machine learning prediction logic datastructure, the milestone document details with respect to matter data associated with the matter to determine relevant matter data;
determine, via any of at least one processor, a set of similar prior matters that are similar to the matter by executing a search query;
datastructure, the milestone document details, the relevant matter data and similar prior matters data associated with the set of similar prior matters with respect to resolution document templates to determine a first best matching resolution document template for the milestone document;
provide, via any of at least one processor, a prompt to a large language model to instruct the large language model to generate a set of template placeholder values for a template placeholder of the first best matching resolution document template;
obtain, via any of at least one processor, user selection of a template placeholder value to utilize from the set of template placeholder values; and
composite, via any of at least one processor, content of the first best matching resolution document template and the selected template placeholder value to utilize to generate a resolution document.

17. A resolution document generating processor-implemented system, comprising:
means to store a component collection;
means to process processor-executable instructions from the component collection, the component collection storage structured with processor-executable instructions comprising:
obtain, via any of at least one processor, a matter milestone interaction request datastructure, in which the matter milestone interaction request datastructure is structured as specifying a milestone document associated with a matter;
determine, via any of at least one processor, milestone document details associated with the milestone document via a natural language processing engine;
evaluate, via any of at least one processor, via a first machine learning prediction logic datastructure, the milestone document details with respect to matter data associated with the matter to determine relevant matter data;
determine, via any of at least one processor, a set of similar prior matters that are similar to the matter by executing a search query;
evaluate, via any of at least one processor, via a second machine learning prediction logic datastructure, the milestone document details, the relevant matter data and similar prior matters data associated with the set of similar prior matters with respect to resolution document templates to determine a first best matching resolution document template for the milestone document;
provide, via any of at least one processor, a prompt to a large language model to instruct the large language model to generate a set of template placeholder values for a template placeholder of the first best matching resolution document template;
obtain, via any of at least one processor, user selection of a template placeholder value to utilize from the set of template placeholder values; and
composite, via any of at least one processor, content of the first best matching resolution document template and the selected template placeholder value to utilize to generate a resolution document.

18. A resolution document generating processor-implemented process, including processing processor-executable instructions via any of at least one processor from a component collection stored in at least one memory, the component collection storage structured with processor-executable instructions comprising:
obtain, via any of at least one processor, a matter milestone interaction request datastructure, in which the matter milestone interaction request datastructure is structured as specifying a milestone document associated with a matter;
determine, via any of at least one processor, milestone document details associated with the milestone document via a natural language processing engine;
evaluate, via any of at least one processor, via a first machine learning prediction logic datastructure, the milestone document details with respect to matter data associated with the matter to determine relevant matter data;
determine, via any of at least one processor, a set of similar prior matters that are similar to the matter by executing a search query;
evaluate, via any of at least one processor, via a second machine learning prediction logic datastructure, the milestone document details, the relevant matter data and similar prior matters data associated with the set of similar prior matters with respect to resolution document templates to determine a first best matching resolution document template for the milestone document;
provide, via any of at least one processor, a prompt to a large language model to instruct the large language model to generate a set of template placeholder values for a template placeholder of the first best matching resolution document template;
obtain, via any of at least one processor, user selection of a template placeholder value to utilize from the set of template placeholder values; and
composite, via any of at least one processor, content of the first best matching resolution document template and the selected template placeholder value to utilize to generate a resolution document.
